(19) United States
(12) Patent Application Publication
(10) Pub. No.: US 2026/0299787 A1
(43) Pub. Date: Oct. 1, 2026

(54) MEMORY READ COMMAND CONFIGURATION FOR ACCELERATED EXECUTION

(71) Applicant: Micron Technology, Inc., Boise, ID (US)

(72) Inventor: Luca Bert, Bologna (BO) (IT)

(21) Appl. No.: 19/094,335

(22) Filed: Mar. 28, 2025

(51) Int. Cl. G06F 3/06

(52) U.S. Cl. CPC G06F 3/0613; G06F 3/0659; G06F 3/0679

(57) ABSTRACT

Systems, methods, and apparatus related to commands for accessing storage spaces of memory systems (e.g., solid-state drive (SSD) having NAND flash memory). A host system sends read commands to the memory systems. The read commands can include normal commands according to a current NVMe standard and fast commands extending the NVMe standard. The memory systems can tell whether a read command is a normal command or a fast command based on the opcode embedded in the command.

### TECHNICAL FIELD

At least some embodiments disclosed herein relate to memory systems in general, and more particularly, but not limited to read command configuration for a memory system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a solid-state drive that receives normal and/or fast commands according to one embodiment.

FIG. 3 shows a data structure used for configuration of parameters in normal and fast commands according to one embodiment.

FIG. 4 shows a format of a read or write command received via a submission queue.

FIG. 5 shows a method for configuring commands to indicate selection of either a normal or fast execution path for processing each command according to one embodiment.

FIG. 6 shows two types (Type A and Type B) of read commands according to one embodiment.

FIG. 7 shows two types (Type A and Type B) of write commands according to one embodiment.

FIG. 8 shows a processing path for Type A read or write commands according to one embodiment.

FIG. 9 shows a processing path for Type B read or write commands according to one embodiment.

FIG. 10 is a block diagram of an example computer system in which embodiments of the present disclosure can operate.

### DETAILED DESCRIPTION

At least some aspects of the present disclosure are directed to techniques for configuring and sending commands from a host system to a memory sub-system. In some embodiments, the commands are sent from a host system to a memory sub-system via a submission queue (SQ) configured in compliance with a standard for non-volatile memory express (NVMe).

For example, a storage space in the memory sub-system is accessed by the host system using the commands sent via one or more submission queues. For example, the commands can specify read or write operations that access the storage space implemented using one or more non-volatile memory devices of the memory sub-system. The commands retrieved from the submission queues can be loaded to an internal command queue of the memory sub-system to execute the commands, including parsing the commands to identify the parameters and options or requirements related to the performing of the read or write operations in the storage space.

The commands sent from the host system can be configured in various ways. In some embodiments, each command is constructed according to a standard of NVMe to have predefined fields and a common total size (e.g., 64 bytes used for each command). In some embodiments, an indication is included in each command to indicate a type of operations to be performed by the memory sub-system during execution of the command.

As used herein, a field is a predefined one or more segments of bits in a command of a specific type. For example, the data structure of a command can be according to an NVMe standard for compliance with the NVMe standard. In one example, a field of an NVMe command corresponds to a set of bits provided in one or more Dword locations in the data representing the NVMe command. In one example, a field can be a range of bytes or bits at a defined location(s) in a command that is not fully in compliance with the NVMe standard.

In some embodiments, normal NVMe commands and fast commands each have a same total size (e.g., 64 bytes) according to an NVMe standard. For example, a command having 64 bytes can be seen as bit segments arranged as Dwords (double words) 0-15. For example, a first field can be configured to use Dword 10, a second field Dword 12, and a third field Dword 13-15. For example, a normal NVMe command can be commands that are fully in compliance with a current version of NVMe standard; and a fast command can be partially in compliance with the current version of NVMe standard (and may be adopted by a future version of NVMe standard). In some implementations, when an opcode of a first normal NVMe command is replaced with an opcode of a second fast command, the second fast command can be executed by the memory sub-system to perform substantially the same operation as the execution of the first normal NVMe command. One or more first fields in the first normal NVMe command and the second fast command configured to provide one or more same parameters for the substantially same operation can be processed during the execution of the first normal command and the second fast command. However, at least one second field, corresponding to the same bit segments having the same value in the first normal command and the second fast command is processed differently for the execution of the first normal command and the second fast command. For example, the execution of the first normal command can involve parsing the second field to extract the parameter provided in the second field and performing further processing to prepare for the performing of the substantially same operation identified by the opcode; in contrast, the execution of the second fast command can skip the parsing of the bit segment to perform the substantially same operation based on a pre-identified configuration. The second field in the first normal command can be modified to specify a different parameter to cause the memory sub-system to perform an operation that deviates from the pre-identified configuration. In contrast, since the second fast command has the opcode that causes the memory sub-system to skip parsing of the bit segment corresponding to the second field in the first normal command, the same value specified in the bit segment to cause the execution of the first normal command to deviate from the pre-identified configuration cannot cause the execution of the second command to deviate from the pre-identified configuration. Thus, the use of the second fast command can speed up the processing of operations in the pre-identified configuration; and the use of the first normal NVMe command can preserve the flexibility to perform operations in a variety of configurations. Since the bit segment corresponding to the second field in the first normal command is not parsed (and thus ignored) in the second fast command, the second field is essentially not configured to have meaning in the second fast command; and the bit segment corresponding to the second field is not used in the second fast command to pass parameters, data, or information from the host system to the memory sub-system.

In other embodiments, normal and fast NVMe commands configured to perform substantially the same operation can each have a different set of fields defined by a range of bit, byte, word, and/or double word locations in a respective command. The normal and fast commands can have some common fields (e.g., namespace identifier and starting LBA) defined at the same locations in each command.

In general, the definitions of fields of a command can vary depending on the value of the opcode specified in the command. For example, depending on the value represented by the segment of bits predefined to store an opcode, many of the Dwords in an NVMe command are partitioned differently into different sets of fields specific to the type of commands represented by the opcode (e.g., read, write, compare, copy, etc.).

In one embodiment, commands executed in a memory sub-system can be optionally normal commands or fast commands. An opcode in a command executed by the memory sub-system can be configured to indicate whether the command is a normal command or a fast command. The normal commands are executed in accordance with fields defined in an NVMe standards to read data from and write data to the storage space of the memory sub-system. To accommodate the variety of options that can be specified for read/write commands according to an NVMe standard, normal read/write commands are processed by the memory sub-system at least in part using firmware-based resources (e.g., firmware instructions executed by a controller).

In contrast, fast read/write commands can be configured to extend a current version of NVMe standard. The fast read/write commands can be limited to a subset of configurations/options that can be specified using the normal read/write commands. Thus, the memory sub-system can be configured to process the fast read/write command using hardware circuitry only and/or without using the firmware-based resources configured to process the normal read/write commands. The opcode in each fast command indicates to a controller of the memory sub-system that a reduced number of fields of the command will be processed. For example, certain of the fields in the data structure of a normal read/write command will be skipped or ignored by a controller when the opcode of the normal read/write command is replaced with the opcode configured to identify the fast read/write command. Optionally, those fields not skipped or ignored are processed using hardware circuitry to reduce or eliminate the use of firmware-based processing, thus accelerating processing of the fast commands as compared to the corresponding normal commands, which can have one or more fields evaluated using firmware-based resources.

In some embodiments, fast commands reduce (but do not completely eliminate) an extent of usage of the firmware-based resources as compared to normal commands. For example, a number of the fields of a fast command processed using firmware is less than a number of the fields of a normal command that are processed using firmware.

A conventional memory sub-system (e.g., a solid-state drive in compliance with a non-volatile memory express (NVMe) standard) can include a flash memory (e.g., NAND memory) that is to be in an erased state before being programmed to store data. For example, such as flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

A conventional NVMe solid-state drive (SSD) can receive commands from a host system via a submission queue and provide completion records about execution of the commands in a completion queue (sometimes referred to as a queue pair (QP)). The host can write to a doorbell register in the SSD to cause the SSD to poll submission queues for commands.

In a typical NVMe implementation, processors (e.g., CPU, GPU, AI accelerators) communicate over a PCIe bus with an SSD via random access memory/main memory of the processor. For example, a pair of message queues in the memory can be used for a processor to send commands to the SSD in the submission queue, and for the SSD to send completion records to the processor in the completion queue.

Each submission queue is a circular queue having slots of the same size. Each slot in a submission queue holds one command for execution by the SSD. Each slot in the completion queue holds a completion record about the execution of a command.

When a processor enters a command in a submission queue configured in the main memory, all related activity occurs within the host system (e.g., the processor and its main memory/random access memory). The SSD is not aware that the processor has entered the command in the submission queue. Instead, the SSD may periodically read the submission queue determine if new commands have been entered. Alternatively, that SSD may have a doorbell register. The processor writes to the doorbell register to notify the SSD to check the submission queue.

In the NVMe standard, the SSD typically reads/writes data in blocks of 512 bytes or more (4 KB is recommended). The NVMe protocol implements certain features for communications between processors and the SSD using access to random access memory. An NVMe command can include various information about operations to be performed (e.g., read or write), a location in a storage space in the SSD for performing the operation, a location in the main memory to store the retrieved data for a read, or a location in the main memory to retrieve the data to be written into the SSD.

With the advent of artificial intelligence (AI), the set of various requirements for storage have become quite uncertain as many parts of the AI pipeline now require significantly different IO profiles from prior profiles used for the storage stack. For example, the entire preparation process for data processing can bring large amounts of data close to where the AI training nodes are located. This will increase SSD capacity. In a similar way, both AI training and inference nodes can use faster SSDs placed in close proximity to the GPU clusters (or even inside the clusters, in some cases). This creates a new set of requirements for SSDs. To meet the challenges, significant changes can be made in how the CPU/GPU communicates to the storage devices (e.g., SSD in this case). At least some embodiments disclosed herein provide major improvements to the NVMe protocol.

Various embodiments related to improvement to NVMe based commands are described below. In some embodiments, new commands can extend the NVMe based protocol in which fast SSDs implementing the new commands can be placed close to the GPU/CPU for improved performance. In some cases, the new commands are configured in a way that is substantially backward-compatible with a current version of NVMe protocol. This permits the improved interface protocol to be used together with the existing stack (e.g., software, firmware, device driver). However, in other cases, the improved interface protocol provides a new interface that is substantially not backward-compatible.

Within a class of applications (e.g., using CPU/GPU attached SSD to address both AI training and inference needs), there are three different areas needing improvement: parallelism, command delivery, and command processing.

Regarding parallelism, the threading level of a GPU can be massive and use a 1:1 matching between GPU threads and SSD queue pairs (QPs), as they are the means to convey thread data to the SSD. For example, current SSDs support up to 2K queues, but it is expected that within the next few years, a typical GPU will have tens of thousands of threads to match. Enqueueing/dequeuing at an N:1 ratio is resource expensive as each insert/remove requires the thread to arbitrate for a lock, acquire the lock, add/remove the entry, release the lock, and then repeat, thus wasting valuable resources and time. The foregoing situation creates the need for the SSD to support a larger number of QPs to match the GPU needs.

Regarding command delivery, the NVMe protocol uses a queuing system that is fast but was not designed for the above scale of operation. Even though the queuing system is flexible and widely adopted, there is a need for an improved queue delivery mechanism.

Regarding NVMe commands, at least some embodiments disclosed herein increases hardware (HW) processing to meet the demands of AI. Processing commands using hardware resources can improve performance, as firmware (FW) intervention can significantly slow processing. The currently used NVMe stack is not designed for such hardware processing as the varieties of options that are infrequently used in general and more specifically in the AI applications generally lead to some level of firmware intervention to manage complexity involved in the processing.

Implementations using NVMe commands according to a current version of NVMe standard have various limitations. When looking at performance, there are two commands that are most relevant: Read and Write.

In focusing on READ and WRITE commands in accordance with a current version of NVMe standard, there are two major limitations in their design. First, the original intent for the NVMe protocol was to provide a simpler interface that ranges from laptop to data center, compute to storage, mobile and automotive devices. As such, the structure must cover multiple, often incompatible, usage models.

The second limitation relates to backward compatibility. For example, in data centers, the NVMe protocol was intended to replace SAS and, to facilitate adoption, would then carry all capability of SAS, including capabilities no longer critical when NVMe was introduced. Further, the Storage SAN protocols are designed for sub-systems and not for devices, and also compatibility with key OEMs. At least some embodiments disclosed herein remove the backward compatibility to simplify the processing of read and write commands.

Existing NVMe Read commands (NVMe Write commands are similar except for minor differences) are structured as follows:
Command Dword 0:
   Opcode: 1 byte (0x02 for READ)
   Fused Operation: 2 bits
   Command Identifier: 2 bytes
Command Dword 1:
   Namespace Identifier: 4 bytes
Command Dword 4-5:
   Metadata Pointer: 8 bytes
Command Dword 6-9:
   Data Pointer: 16 bytes (split into two 8-byte fields)
Command Dword 10-11:
   Starting LBA (Logical Block Address): 8 bytes
Command Dword 12:
   Length: 2 bytes (number of logical blocks to read)
   Control: 2 bytes
Command Dword 12-15: Command-specific fields, often reserved or used for additional control parameters.

When desiring fast processing, many of the parameters in the command are not necessary. For example, the “fuse operation” parameters can be removed. In some cases, certain parameters can be optimized.

More significant problems relate to parameters in the fields of Command Dword 12-15. For example, some parameters are not useful for high-performance fast processing (e.g., “Limited Retry”, “Force Unit Access”). Other parameters are redundant. Yet other parameters can be improved by optimization. For example, “Storage Tag Check” and “Protection Information” are parameters that are attributes of the Namespace, and so can be set as static values at the time of namespace (NS) creation. These parameters do not need to be repeated in every command. They are present to provide compatibility with existing software management that was designed for SCSI/SAS-based hard drives.

The presence of such unnecessary parameters in commands presents a significant technical problem. Even if parameters are not relevant to a command operation, the mere existence of the parameters in the command requires that the parameters be evaluated and any corresponding action taken. In effect, this prevents the command from being effectively accelerated because of parameters that, in such high-performance cases, are not needed and need firmware intervention.

For example, the above problem exists for Command Dword 13-15 for Read commands. There are many control parameters provided here to allow flexibility and backward compatibility. However, these parameters cause a technical problem for processing using a high-performance path, both because these parameters are not needed and would make full hardware acceleration impractical.

In addition to the above, there are other technical challenges associated with NVMe devices. As SSDs have increased in speed, more recent systems use an SSD as secondary memory in AI applications. For example, many GPU cores/threads may have parallel requests to the SSD for such applications. It can be advantageous to use one queue pair (a pair of submission queue and completion queue) for each thread. However, AI applications in some cases can have a very large number of parallel threads (e.g., thousands or more). But, for example, a typical SSD is limited to handling only 1024 submission queues (e.g., because of the hardware/controller used in the SSD). As a result, the host needs to run software to combine commands from multiple threads into a single submission queue. This can cause inefficiencies due to synchronization required for handling the combination of commands from these threads.

In one example, an NVMe interface is used for communication between a GPU or other host on one side of a connection fabric (e.g., PCIe fabric) and an NVMe SSD on the other side of the connection fabric. This interface is used by the GPU or host to send NVMe commands to the SSD and to receive NVMe command completions.

For example, the NVMe interface passes NVMe commands and gets completions as described in NVMe spec 2.0. This interface uses NVMe Submission Queues, Completion Queues, and NVMe doorbells. This interface was designed for use cases in which the number of threads is fairly limited. However, as mentioned above, new use cases having large numbers of threads are emerging for which this interface is not efficient. Thus, there is a need for an improved NVMe interface to cope more efficiently with these new use cases.

In one example of a NVMe use case, threads running in a host operating system (OS) issue NVMe commands. These OS threads (e.g., 100-900 threads) are factored on host logical CPUs (sometimes referred to herein as LCPUs) with one queue pair (QP) associated to each logical CPU. This is done because OS threads are scheduled one at a time on an LCPU.

Even if there are thousands or more OS threads doing input/output operations (IOs) on a host server, only a few hundred (number of host LCPUs) actually access QPs at the same time. This limitation exists because at any given time, only one thread can run on a given LCPU.

Because the QP associated to the LCPU is updated by one thread at a time (the one currently running on the LCPU), there is no need for synchronization between threads regarding QP updates. However, the QP update is typically enclosed by synchronization code to handle the rare situation of one or more LCPUs being removed. This synchronization code doesn't generate significant overhead.

The synchronization is typically implemented via an atomic variable, one per QP. A test-and-set operation is done on that atomic variable. For example, the atomic variable AVi for QPi stays in the L1 cache of LCPUi associated to QPi. A thread running on LCPUj accesses only AVj and never AVi. Consequently, the atomic variable stays exclusive in the L1 cache, and modifying the atomic variable requires about one clock cycle.

An NVMe Completion Queue of a QP is polled by only one thread at a time, running on the LCPU associated to the QP. Hence, the most likely situation for the submission queue (SQ) is that there is no need of synchronization. For this use case, the NVMe interface typically operates satisfactorily.

However, as mentioned above, there are new emerging NVMe use cases in which a processor (e.g., a GPU) issues a large number of NVMe commands. For example, in these use cases hundreds of thousands of GPU threads can access the NVMe QPs simultaneously. This is significantly more than the number of threads for the few hundreds of LCPUs of the use case above.

The thread synchronization required above presents a technical problem that induces significant GPU overhead when queuing NVMe commands and getting their completion status. This overhead is incurred by the threads on the GPU when the threads synchronize the access to NVMe submission queues (SQs) and completion queues (CQs). Implementing this synchronization code robs processing cycles and/or resources from the GPU (e.g., a Streaming Multiprocessor (SM) of the GPU).

Now discussing this increased overhead need in more detail, on an NVIDIA GPU, for example, threads run on Streaming Multiprocessors. A GPU contains typically between one and two hundred SMs. Each SM can run several hundreds or thousands of threads in parallel.

Similarly to the NVMe use case above, it can be desirable to have only one thread at a time using a QP. In such case, there could be a need, for example, for several hundred thousand NVMe QPs. Each QP would have one or very few NVMe commands (and most of the time typically only one command) queued in the QP submission queue. The creation of these QPs would be time-consuming, and these QPs would waste a lot of SSD hardware resources.

Having a limited number of NVMe QPs available, one can consider how the use of the QPs might potentially be optimized in the above GPU use case. Noting that all threads running on a same Streaming Multiprocessor (SM) share the same L1 cache, an efficient use of NVMe QPs is to use one QP per SM. Any thread running on the SM can use the QP associated to the SM. Doing so guarantees that the serialization atomic variables (e.g., used to serialize access to the QP across threads running in parallel on the SM, one set of atomic variables per QP) and the QP itself stays in the SM L1 cache. No other thread running on another SM is going to access the QP.

When contention happens (e.g., several threads running on the same SM post in the SQ or read the CQ), the contention is handled in the SM L1 cache, and there is no need to access the GPU main memory. This reduces SM thread stalls (e.g., cache miss is avoided) by handling the contention in L1 cache, and also reduces the usage of memory bandwidth.

However, the above approach still has significant limitations. Specifically, the threads running on a same SM must wait in turn to access the QP, one after the other. The threads wait by looping doing atomic operations on the QP atomic variables, to know when it is a thread's turn to access the QP. This creates undesirable SM overhead.

In some approaches, a part of the queueing can be done in the same SQ in parallel (e.g., writing NVMe commands in parallel in different entries of the SQ). But these approaches themselves also require the use of atomic variables. Some parts of the queuing cannot be done in parallel. For example, the SQ doorbell update and ensuring that SQ content is consistent with the doorbell value must still be serialized. For completion queues (CQs), memory atomic operations are used again to synchronize several SM threads reading the CQ associated to the SM.

Thus, even if attempts were made to improve queuing by assigning QP(s) per SM (e.g., atomic memory variables used for synchronization stay in L1, and contention is reduced to intra SM) and writing is done in parallel in SQ entries, there is still undesirable overhead having the SM use atomic memory operations (e.g., in particular at high frequencies).

At least some techniques provided in the present disclosure address the above and other deficiencies and challenges by providing a memory sub-system that can selectively process commands using either a normal execution path (e.g., for read/write commands in compliance with a current version of NVMe standard that provides extensive options and/or backward compatibility) or an accelerated execution path (e.g., for new, extended read/write commands that are in compliance with a current version of NVMe standard in some aspects for compatibility but not other aspects to reduce options and/or backward compatibility to old technologies that are not likely being used). For example, the normal execution path is supported by using firmware-based resources to handle various parameters included in commands. The accelerated execution path reduces or eliminates usage of the firmware-based resources. Commands processed using the normal execution path are sometimes referred to as being processed in a normal mode. Commands processed using the accelerated execution path are sometimes referred to as being processed in a fast mode. For example, processing of a type of operation (e.g., reading a block of data from, or writing the data to, the storage space of the memory sub-system at a logical block addressing (LBA) address) in the fast mode is faster than processing of the same operation in the normal mode.

In one embodiment, both normal and fast commands use a compatible data layout for data stored in the storage space of a memory sub-system. For example, data written to a block of the storage space with a normal write command can be read from the same block using a fast read command. Data written to a block of the storage space with a fast write command can be read from the same block using a normal read command. This provides backward compatibility.

In some embodiments, when commands are configured to include a first opcode that is designed to indicate to a memory sub-system (e.g., solid-state drive) that a command is to be processed using the accelerated execution path, the path skips or ignores processing of certain bit segments that would be recognized as fields in an alternative command generated by replacing the first opcode with a second opcode that is designed to indicate to the memory sub-system to use the normal execution path. Thus, the processing of the commands having the first opcode can be fully implemented in hardware of a memory sub-system according to one embodiment.

In some embodiments, a memory sub-system (e.g., NVMe solid-state drive) has execution paths selectable by a host system to bypass firmware-based processing. The memory sub-system is configured with a hardware accelerator to process basic parameters of standard NVMe read/write commands, and firmware programmed to further process optional/additional control parameters of each respective command.

Optionally, an indication can be provided to the memory sub-system to disable the processing of certain fields of a command as if such parameters in the field(s) were known to the memory sub-system and/or not present via the command. For example, a command can cause the memory sub-system to enter a fast mode of ignoring predetermined fields for optional/additional control parameters (e.g., fuse operation parameters in Command Dword 0, and some fields in Command Dword 12-15). When operated in such a fast mode, the processing of a command specified in accordance with a current standard of NVMe is accelerated using hardware to reduce or eliminate firmware-based processing of some options that are allowed in accordance with the current standard of NVMe.

When the memory sub-system is in a normal mode of operation, the memory sub-system can further execute firmware to examine the fields for optional additional control parameters and, if such parameters are provided, process them according to the NVMe protocol or standard.

In one embodiment, the fast mode can be triggered via a command for a period of time until another command causes the memory sub-system to enter the normal mode. For example, the fast mode can be identified via the opcode provided in the Command Dword 0, or another field provided in the command, such as an optional field configured in another Command Dword; and the memory sub-system is to process the command in the fast mode.

In one embodiment, a memory sub-system has a host interface configured to receive first commands (e.g., normal NVMe commands) and second commands (e.g., fast NVMe commands). Each command has a first field and a second field. The memory sub-system has a controller that processes the first commands using a first mode (e.g., normal mode) in which the first and second fields are processed, and the second commands using a second mode (e.g., fast mode) in which the first field is processed and the second field is ignored.

For example, the first field is processed in the first and second modes using hardware circuitry. The second field is processed in the first mode at least in part using firmware. The firmware is not used for any processing in the second mode.

Each of the first and second commands includes an opcode (e.g., indicating a normal NVMe read execution path or a fast/accelerated read execution path). The controller selects either the first or second mode for handling a received command based on the opcode.

For example, processing of the commands is hardware accelerated. The delivered commands are simplified so that an ASIC is able to complete them without firmware intervention. This approach maximizes speed. Although firmware is needed for error and exception handling, this approach completely removes firmware processing from the accelerated data path for execution that does not result in errors.

Optionally, the new commands can be configured to facilitate sub-block transfers. For example, artificial intelligence implementations use a range of various features. In one example, AI inference requires transfers that are significantly small and not aligned to the SSD LBA structure. For example, a GPU may need 128 bytes (cache size) that sits in an LBA address x at an offset of 256 bytes. If a controller reads the entire LBA block (4 KB) into the host memory, it can consume a significant amount of host memory, only for the host to extract the 128B from the byte range of 256 to 256+127, and move the extracted data to GPU memory. This is time consuming and limits performance. In contrast, a new command disclosed herein can be configured to cause the memory sub-system (e.g., a solid-state drive) to transfer just the required 128B to the required address, regardless of where this data is located inside the LBA block.

For example, the new commands can be implemented in a manner that is backward-compatible to a certain degree with existing NVMe interfaces. While this is not strictly necessary, the ability of the new commands to be used with existing storage stacks is an advantage in some situations. In other situations, the new command interface can be used stand-alone in a different way that is not necessarily compatible with existing NVMe. In such other situations, the new commands can be compacted in a way to further maximize performance.

In one example, a processor (e.g., GPU) generates commands retrieved by an SSD over a PCIe bus. For example, the processor can be a GPU Streaming Multiprocessor (e.g., NVIDIA GPU), a host core, or other similar physical processing unit running code that issues NVMe commands.

In one embodiment, a memory sub-system stores data in non-volatile memory cells. A controller of an SSD receives work requests from a host system. For example, each work request includes an access command. In response to receiving each work request, the controller executes the corresponding access command in the received work request to perform an operation on the non-volatile memory cells.

In one embodiment, an SSD includes at least one non-volatile memory device and one or more controllers. The SSD stores data for a host system on which a plurality of threads execute for training a neural network(s).

In one embodiment, a memory sub-system (e.g., an NVMe device) is configured to provide access to a host system. The host system can read/write the NVMe device using an NVMe block command set based on addressing in a block namespace, where the full LBA block of data is transmitted across the PCIe bus for read or write.

In one example, a read and write can be performed using an NVMe memory namespace command set. An NVMe device can be configured to perform a read operation to retrieve the data from a set of memory cells allocated as the storage resources of an LBA block.

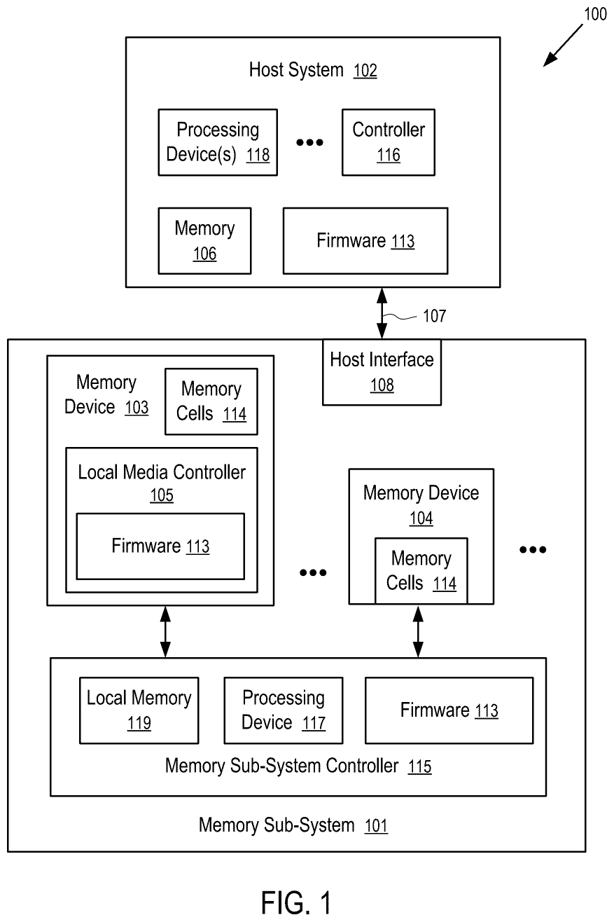

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include firmware 113 (e.g., using a submission queue) configured to receive commands (e.g., access commands) from one or more host systems 102. In various embodiments, the firmware 113 is used to exchange input/output (IO) commands and completions between a host system (e.g., a GPU) and a memory sub-system (e.g., an NVMe SSD).

In some embodiments, the controller 115 in the memory sub-system 101 includes at least a portion of the firmware 113. In other embodiments, or in combination, the controller 116 and/or the processing device 118 in the host system 102 includes at least a portion of the firmware 113. For example, the controller 115, the controller 116, and/or the processing device 118 can include logic circuitry implementing the firmware 113. For example, the controller 115, or the processing device 118 (processor) of the host system 102, can be configured to execute instructions stored in memory for performing the operations of the firmware 113 described herein. In some embodiments, the firmware 113 is implemented in an integrated circuit chip disposed in the memory sub-system 101. In other embodiments, the firmware 113 can be part of firmware of the memory sub-system 101, an operating system of the host system 102, a device driver, or an application, or any combination therein.

For example, the firmware 113 implemented in the controller 115 and/or 105 of the memory sub-system 101 can configure processing of commands in various ways. In some embodiments, an indication is included in each read or write command to indicate a type of processing (e.g., normal or fast mode) of the command to be performed by the memory sub-system 101. Normal commands are processed by the memory sub-system at least in part using firmware-based resources. Fast commands are processed by the memory sub-system 101 using hardware circuitry only. Host system 102 sends commands to the memory sub-system 101 over a PCIe fabric. Controller 115 executes the commands (e.g., NVMe commands) to access memory device 103.

In one example, the controller 115 can run the firmware 113 of the memory sub-system 101 to retrieve commands from the host system 102 over a PCIe fabric. Controller 115 executes the commands (e.g., NVMe commands) to access memory device 103. Controller 115 indicates completion of the commands to host system 102 by sending signals over the PCIe fabric.

In one example, managers in the host system 102 and in the memory sub-system 101 are configured to establish namespaces. For example, the namespace can be an NVMe block namespace. The smallest unit of storage space accessible in the namespace is a block represented by a respective address defined in the namespace to represent the block. For example, the storage size of a block can be 512 bytes or more (e.g., 4096 bytes). A set of physical storage resources (e.g., memory cells 114) are allocated to implement the physical storage space represented by the namespace.

In one example, memory sub-system 101 is configured to access a region of storage locations. Host system 102 can use a protocol (e.g., a NVMe block command set) to send an access request to an SSD. The access request is directed to an address in a namespace; and the memory sub-system 101 can provide a corresponding response using the protocol.

For example, the access request sent to the SSD can be a read command. The memory sub-system 101 can execute the read command and determine the storage resource allocated to implement a logical block having the address defined in the namespace. The memory sub-system 101 then retrieves a data block from the storage resource, and sends the data block across the computer bus 107 to the memory 106 of the host system 102, as instructed by the access request according to the protocol.

For example, the access request sent to the SSD can be a write command. The memory sub-system 101 can use an address map to determine a storage resource block allocated to implement a logical block having the address defined in the namespace. After retrieving the data block from the memory 106 of the host system 102, as instructed by the access request according to the protocol, the memory sub-system 101 can program the storage resource block to store the data block obtained from the memory 106 of the host system 102.

Further details of the operations of the firmware 113 in the host system 102 and in the memory sub-system 101 are discussed below.

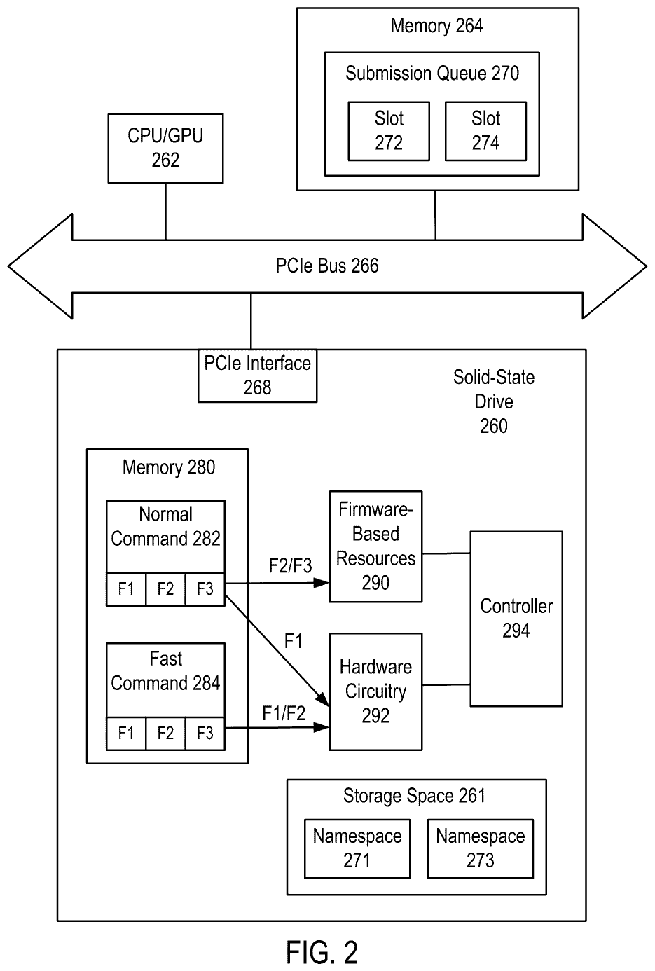

FIG. 2 shows a solid-state drive 260, configured to implement a memory sub-system 101 of FIG. 1, that receives normal and/or fast commands 282, 284 according to one embodiment. CPU/GPU 262 communicates with memory 264 and solid-state drive 260 using PCIe bus 266. Memory 264 has a submission queue 270 for holding commands (e.g., NVMe read or write commands 282 and fast commands 284) to be retrieved by the solid-state drive 260. CPU/GPU 262 generates the commands and places each command into one of slots 272, 274 of submission queue 270 (e.g., configured according to a standard of NVMe).

CPU/GPU 262 and memory 264 are an example of host system 102. Solid-state drive 260 is an example of memory sub-system 101.

Solid-state drive 260 retrieves the commands from the submission queue 270 via PCIe interface 268. The retrieved commands are buffered in the local memory 280 of the solid-state drive 260. In one example, memory 280 is a command queue of solid-state drive 260. In one example, memory 280 is buffer memory or local random access memory for temporary storing of commands waiting to be processed/executed.

Each command 282, 284 has a common size in bytes. Each command can include fields F1, F2, F3 (and other fields) at the same bit segments of the commands. For example, the data structure of the normal command 282 corresponds to a command structure defined in a current version of the NVMe standard; and each field F1, F2, or F3 in the normal command 282 corresponds to a predefined location (e.g., bit segments) in the normal command to provide a parameter in a way defined in the NVMe standard. The fields F1, F2, and F3 in the fast command can be the corresponding bit segments in the normal command 282. The meaning of the parameters provided in some of the fields F1, F2, and F3 in the fast command can be different from what is specified in the NVMe standard; the meaning of the parameters provided in some of the fields F1, F2, and F3 in the fast command can be the same as what is specified in the NVMe standard; and some of the fields F1, F2, and F3 in the fast command can have no meaning and are thus ignored (e.g., skipped in processing). In one example, field F1 corresponds to a set of one or more Dwords, field F2 corresponds to another set of one or more Dwords, and field F3 corresponds to yet another set of one or more Dwords.

Each command 282, 284 includes an indication of a type of processing to be performed by controller 294 when executing the command. The indication indicates how each field of the command is to be processed (e.g., as a fast command or a normal command).

Normal commands 282 are processed using a normal execution path. This path includes use of firmware-based resources 290 and hardware circuitry 292.

Field F1 in the normal command 282 and the fast command 284 is processed using only hardware circuitry 292. For example, field F1 is a data pointer or starting LBA address.

Field F2 in the normal command 282 is processed using firmware-based resources 290. For example, field F2 is Dword 13 of an NVMe read command containing parameters/options (e.g., for Dataset Management and/or other parameters). Field F2 in the fast read command 284 can have no meaning, or be repurposed to provide one or more different parameters different from the parameters provided in Field F2 in the normal command 282.

Field F3 in the normal command 282 is processed using firmware-based resources 290. For example, field F3 is Dword 14-15 of an NVMe read command containing command-specific parameters. Field F3 in the fast read command 284 can have no meaning, or be repurposed to provide one or more different parameters different from the parameters provided in Field F3 in the normal command 282.

Fast commands 284 are processed using an accelerated execution path. This path includes use of hardware circuitry 292 without any use of firmware-based resources 290.

In one example, SSD 260 has a DMA engine (not shown) to retrieve data/commands from the memory 264 and write data/completion records to the memory 264.

The data in a slot in a submission queue 270 (e.g., as configured according to the NVMe standard) is seen by the solid-state drive 260 as a command. The controller/processor 294 of the SSD checks various segments/fields of the data/command to determine what operations/tasks the CPU/GPU 262 wants the SSD to perform by entering the command/data in the slot 272, 274.

In accordance with a current version of NVMe standard, each NVMe command has a total size of 64 bytes, or 16 Dwords (double words), that can be referenced as Dword 0 to Dword 15. When Dword 0 has the opcode value for a normal read as defined in a current NVMe standard, the command is interpreted as a normal read command; when the Dword 0 has the opcode value for a normal write as defined in a current NVMe standard, the command is interpreted as a normal write command.

For a normal command, Dword 0 also has a two-bit field to specify a “Fused Operation”. If the value of the field is “00”, there is no fused operation. If the value of the field is “01”, the command is a first command for fused operation. If the value of the field is “10”, the command is a second command for fused operation.

For a fast command, as indicated by an opcode value for a fast read (or write) that is different from the opcode as defined in the current NVMe standard for read (or write), the SSD 260 does not examine or check the value in the segment location of data that corresponds to the field “Fused Operation” of a normal NVMe command. The SSD 260 executes the fast command with the assumption that there is no fused operation, as if “00” were specified in the corresponding location for specifying “Fused Operation” in a normal command. Thus, the fast command is limited to operate in the pre-identified configuration of “no fused operation”, even when “01” or “10” is specified in the field. In one embodiment, the opcode field is used to indicate that a command is a fast command. In other embodiments, a fast command can be indicated to SSD 260 using another indication provided in another field (e.g., a vendor-specific field or a reserved field) of the command. For example, the meaning of a value of “11” specified in the fused operation field is reserved in the current NVMe standard. It can be extended to indicate that the command is a fast command, which allows the fast command to use the same opcode for a normal read in a fast command. In such an implementation, the SSD can have a hardware circuit to check whether the fused operation field has a value of “11” to determine whether the command is a fast command to be processed using an accelerated execution path.

In one example, SSD 260 supports both a normal read/write command/mode having one or more fields that are parsed and processed according to a standard of NVMe; and a fast read/write command/mode in which these fields are simply ignored by the SSD. In some embodiments, instead of being ignored, these one or more fields are interpreted in a different way in the fast mode.

In some embodiments, a fast read or write command is processed with the assumption that the fields of the command provide a set of predefined/fixed values, regardless of the actual content in the fields. When a field in a standard NVMe is eliminated/not processed for a fast command, the information normally sent from the host system to the SSD in a normal command using this field is not transmitted or processed. For example, a namespace creation command is used by a host system to send namespace metadata/attributes to be used in subsequent read/write commands. For example, if a default namespace is established, then the namespace field can be eliminated; the fast command is processed as if the command has the default namespace identified in the namespace field. For example, if the namespace field is eliminated, the hardware of the SSD can be preconfigured to use the default namespace; and a routine to extract the namespace from the fast command and setting up the use of the namespace can be skipped (because the processing work was previously done).

SSD 260 includes storage space 261. For example, the storage space can be implemented via NAND flash memory. A fast or normal read/write command is executed in the SSD 260 to read data from, or write data into, storage space 261.

The capacity of the storage space 261 can be partitioned into one or more namespaces 271, 273. Physical storage resources (e.g., NAND flash memory) are allocated to implement logical storage blocks in namespaces 271, 273. A namespace 271 or 273 can have a plurality of logical storage blocks, each having a same size and represented by a logical block addressing (LBA) address configured in the respective namespace 271 or 273. For example, to specify a location in the storage space 261, a fast or normal read/write command can specify a namespace identifier in a “namespace identifier” field configured in the respective command (e.g., Dword 1 or bytes 7:4 of the command), and an LBA address in a “Starting LBA (SLBA)” field in the respective command (e.g., in Dwords 10-11 or bytes 47:40 of the command), where the LBA address is defined specifically in the namespace represented by the namespace identifier.

In one embodiment, normal and fast commands 282, 284 use a compatible data layout for data stored in storage space 261. For example, data written to a block of the storage space (e.g., in namespace 271) with a normal write command 282 can be read from the same block using a fast read command 284. Data written to a block of the storage space 261 with a fast write command 284 can be read from the same block using a normal read command 282.

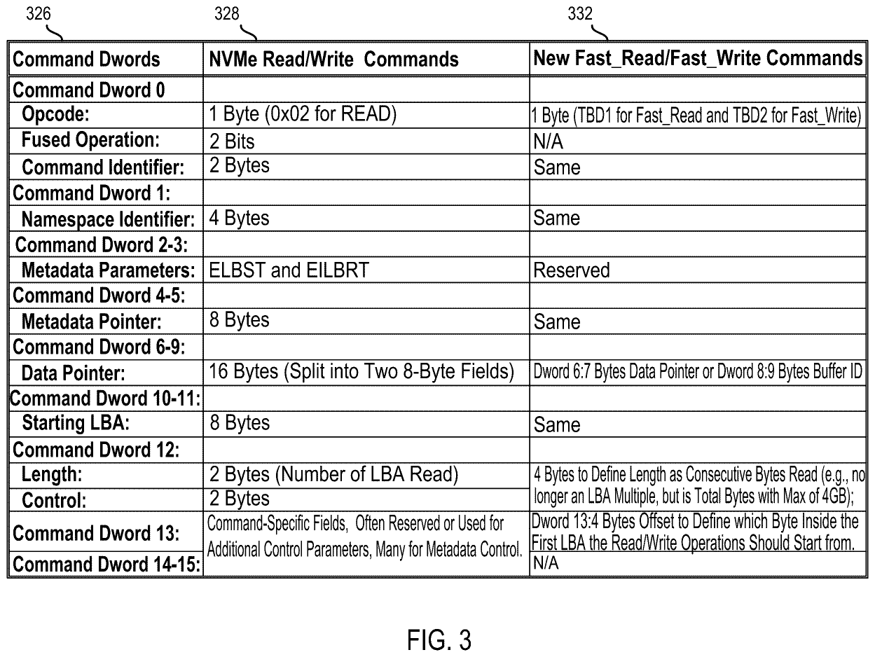

FIG. 3 shows structures of normal commands and fast commands according to one embodiment. As illustrated in FIG. 3, each read or write command, which can be a normal command 328 or a fast command 332, has a same total size of 16 Dwords (64 bytes, or 512 bits) in accordance with a current standard of NVMe. The 512 bits of a command can be broken into Dwords 0 to 15 for convenience in referencing, as illustrated in column 326.

Columns 326 and 328 show how various segments of bits in a normal command in compliance with a current NVMe standard are used to carry parameters of a read or write command. Column 332 shows an example of a fast command that has a reduced and/or modified set of parameters that are configured in some bit segments in a way similar to how the parameters of the normal command are carried.

For example, the parameters of “Opcode”, “Fused Operation”, and “Command Identifier” (or Command ID) of a normal read/write command are configured in Dword 0. The Opcode field occupies a bit segment of 1 byte in Dword 0; the Fused Operation field occupies another bit segment of 2 bits in Dword 0; and the Command Identifier field occupies a further bit segment of 2 bytes in Dword 0. Some bits in Dword 0 are reserved in the current NVMe standard and thus not used to carry parameters of meaning as defined in the standard. The Dword 0 of a normal command can further include a field to indicate whether PRP (Physical Region Page) or SGL (Scatter Gather Lists) is used for data transfer. For example, an opcode value of 0x02 can be used in the Opcode field to identify the command as a read command according to the NVMe standard; and an opcode value of 0x01 can be used in the Opcode field to identify the command as a write command according to the NVMe standard. In some embodiments, a fast command is configured to use the same bit segment to carry an opcode. For example, a value different from 0x02 and not currently in use to represent another type of command in the NVMe standard can be used to indicate that the command is a fast read command; and a further value different from 0x01 and not currently in use to represent another type of command in the NVMe standard can be used to indicate that the command is a fast write command. Alternatively, a bit in a Dword currently reserved in the NVMe standard (e.g., one of bits 13:10 in Dword 0) can be used to carry an indication of whether the command is a fast command or a normal command. For example, when the bit has a value of zero (0), the command is to be recognized as a normal command; and when the bit has a value of one (1), the command is to be recognized as a fast command. Alternatively, a reserved value in a field currently used in the NVMe standard can be repurposed to indicate that the command is a fast command. For example, consider the value of 0x03 in the field for specifying whether PRP or SGL (e.g., bits 15:14 in Dword 0) is used for data transfer. This value can be used to indicate that the command is a fast command that does not use PRP or SGL for data transfer. In such a manner, the bit segments of normal read/write commands to carry a parameter as defined in the NVMe standard can be modified to accommodate the transmission of parameters for fast read/write commands with reduced or minimized conflicts with definitions in current NVMe standards.

For example, normal commands 282 in FIG. 2 can have a command format as illustrated via columns 326 and 328. Fast commands 284 in FIG. 2 can have a command format as columns 326 and 328 further modified as via column 332. In one example, controller 294 and/or hardware circuitry 292 examine and process parameters identified in FIG. 3. The number of fields processed for a fast command 284 can vary depending on embodiments.

A comparison of the command structures of a normal command 282 and a fast command 284 as defined in the embodiment of FIG. 3 is now described below. Examples of fast commands 284 are sometimes indicated as FAST_READ and FAST_WRITE commands. The FAST_READ and FAST_WRITE commands can be used to provide an accelerated high-performance data operation. These fast commands can coexist with existing read and write commands (sometimes referred to as READ and WRITE) for processing in a memory sub-system 101 of FIG. 1 and/or a solid-state drive 260 of FIG. 2. A host system can send any mix of normal and fast commands to such a memory sub-system 101 or solid-state drive 260 for execution. The host system can select this mix depending on whether accelerated performance is desired or data management is to be performed. The fast commands can be used inside the same namespace as normal commands. The fast commands are coherent in the namespace in the same fashion as for existing read and write commands. For example, the fast commands can be compatible with and additive to NVMe standards. Optionally, a memory sub-system 101 of FIG. 1 can choose to implement fast read/write commands without implementing normal read/write commands; in such implementations, it is not necessary to configure a command in a way to explicitly indicate whether the command is a fast command or not. For example, the opcode values 0x02 and 0x01 can be reused as opcodes for fast read/write commands without using a further bit or field to indicate that the command has the format as modified from an NVMe format according to column 332. For example, the fast read/write command format can be adopted in a future version of NVMe standard as read/write command after the use of the command format as illustrated via columns 326 and 328 is discontinued in the future NVMe standard.

Each of the fast commands uses a 64-byte data structure to maintain NVMe compatibility.

Various fields are now described below. This includes modifications to fields, potential performance impact, and disposition of a field value for processing.

Command Dword 0 (i.e., the first four bytes of a command) contains the same opcode field (e.g., bits 7:0) for both a normal command and a fast command for improved compatibility. New opcode values can be defined for fast commands. Command Dword 0 also contains the Command identifier (ID) that is used for identifying commands in a queue. This parameter field can be kept in the fast read/write commands as currently specified in the NVMe standard for normal read/write commands to support NVMe compatibility.

However, fused operations are not supported for fast read/write commands. The fuse command is used for getting locks (e.g., read data and if zero, write 1, so get a lock) in an atomic fashion. The fuse command is not used for fast commands as the targets are data and not locks. If a lock is necessary, the lock can be acquired with a fused read and write as currently done in NVMe. This will not affect fast commands. Thus, the “Fused Operation” bits (e.g., bits 9:8 in command Dword 0 configured for defining fused operation in a normal command) can be ignored in a fast command and are indicated as N/A in column 332. The memory sub-system 101 of FIG. 1 and/or solid-state drive 260 of FIG. 2 can execute the fast command according to the pre-selected configuration of “00” being specified in the “Fused Operation” bits (e.g., bits 9:8 in command Dword 0) regardless of the actual content in the “Fused Operation” bits in the fast read/write command. Alternatively, as discussed above, since the value of “0x03” is currently reserved for the “Fused Operation” bits in the NVMe standard, the value of “0x03” can be used in the “Fused Operation” bits to indicate that the command is a fast command, even though the opcode field of the command has the opcode “0x02” or “0x01” for read or write according to NVMe standard.

Regarding Command Dword 1, the Namespace Identifier (NS) will be configured in a fast command in the same way as in a normal command. Dwords 2-3 carry some metadata information (e.g., ELBST and EILBRT in bits 47:00 of Dwords 2-3). This can be removed from fast commands of one embodiment.

Regarding Command Dword 4-5 (Metadata Pointer), in some embodiments the fast commands do not use metadata and this field can be ignored. In other embodiments, the fast commands include this field. For example, metadata may have value in certain implementations, or possible future usage. The metadata is handled in a way that maintains backward compatibility. For this purpose, the metadata pointer is the same for both normal commands and fast commands. However, information on how the metadata is to be handled, which is kept in Dword 12 and other fields, is restructured for fast commands.

In normal NVMe read and write commands, byte 12 of Dword 12 in the 64 byte Dword data structure carries PRINFO and STC information that instructs an SSD how to handle the metadata. This is done on a command-by-command basis so that a system, for backward compatibility, can use this information as desired. However, in more modern systems, metadata is an attribute that is constant throughout the entire namespace and allowing each command to behave differently is a source of unnecessary complexity.

In one embodiment, for fast commands all command-specific fields are removed from Dword 13, and the ELBST and EILBRT parameters are removed from Dword 3. Instead, this information is used as namespace attributes that apply to more than one command. In one embodiment, all fields are removed from Dword 13-15.

In one embodiment, to use the removed information as namespace attributes, the namespace creation command is modified. Alternatively, a separate command is used to add namespace attributes. The namespace creation command and/or the separate command to add namespace attributes are used to communicate to the SSD the metadata type to associate with each namespace. With this approach, each FAST_READ and FAST_WRITE only uses the data pointer without using any other variable option. The SSD will know what type of metadata are used for the targeted namespace and will use the metadata accordingly. This simplifies the command extraction and data movement, while allowing any desired metadata models to be used. It also has the advantage of preventing unnecessary mixing of different metadata in the same namespace.

The above simplification over the normal command to have a format for a fast command provides an advantage because metadata management can involve many possible combinations of settings that need to be analyzed and disposed of. Doing this dynamically command-per-command is expensive and resource intensive. In contrast, moving this processing to a namespace attribute set up approach allows the proper setting for that namespace to be created at the beginning prior to using commands, and the proper setting is then continuously reused on each subsequent command. This avoids having to recompute the proper settings for each command.

In one embodiment, the following activities are performed: configuration of metadata type at namespace creation, changing metadata type, deleting metadata type, and/or reporting metadata type. These activities can be implemented using additional commands, modifications to equivalent NVMe commands, and/or newly-created commands.

For example, with the above organization, when a command with an IO request is received, it will be dispatched to an ASIC (application specific integrated circuit) that has already been prepared to handle metadata as indicated by the namespace attributes. The ASIC can perform all necessary checks or generation, and report errors using existing NVMe error codes.

Regarding Dword 10-11 (Starting LBA), this field relates to the first LBA address (starting LBA) that will be accessed in response to receiving a command. This field will be configured in a fast command in the same in way as in a normal command for improved compatibility.

Regarding Dword 6-9 (Data Pointer), some changes in use of the fields are made for fast commands as described below. First, it is noted that for NVMe commands, Dword 6-7 contains a data pointer if a system wants to read/write a single LBA. In the case that a system wants to read/write multiple LBAs, the system additionally adds Dword 8-9 as a pointer to a PRP list of the other LBAs to read/write.

Regarding Dword 12 (Data Length and Control) as used in NVMe commands, a Number of Logical Blocks (NLB) field configured in Dword 12 of a normal command (e.g., bits 15:0) is used in NVMe standard to specify the number of LBAs to read/write in the execution of the normal command. Using an integer value in the field can specify the data length for read/write as a multiple of LBA block size. However, there is not a way to specify a fraction of one LBA block in the NLB field to address a sub-block.

Changes for data length are made for the new fast commands. In one embodiment, at least a portion of Dword 12 (or the entire Dword 12) of a fast command is configured to carry the parameter of data length, but this length is expressed in bytes rather than a number of LBAs. For example, this size value will be, in most common applications, 4K times larger than for current NVMe. As such, 12 additional bits, in addition to the 16 bits of NLB field configured in Dword 12 of a normal command, can be allocated from the fast command (e.g., Dword 12) to specify the data length in bytes. Optionally, the full 4 bytes of Dword 12 of the fast command can be configured to specify the data length for read/write. In some cases, the data length can be expressed using another unit of data other than a byte, such as a data length expressed as a number of units each having a size of, for example, 32 B, 64 B or 128 B.

Another change that impacts data length is that a read/write operation will start at an LBA address. For example, if a system desires to read a sub-block of, say, 128 bytes, this value is specified in this length field. However, in some cases, the sub-block needed is not at the beginning of the LBA. Instead, the sub-block is located somewhere inside the LBA. For example, a system can request to read 128 bytes, starting from byte 1024 of LBA 0x1234.

Regarding Dword 13, a new parameter referred to as “offset” is added to fast commands to specify where the data transfer begins inside the first LBA to read or write (e.g., the value of 1024 in the above example). To implement this, Dword 13 is repurposed. In one embodiment, all existing NVMe parameter fields configured in Dword 13 of a normal command are either removed or reconfigured to provide via NameSpace attributes so that Dword 13 of a fast command is free and available for carrying the offset. For example, a request to read 128 bytes, starting from byte 1024 of LBA 0x1234 will be expressed by using Dword 10-11 for LBA (0x1234), Dword 12 for length (128 bytes), and Dword 13 for offset (1024). Optionally, the offset field of the fast command can be configured in other locations that are not used to carry other parameters.

Using the above approach in various embodiments, a host system can direct an SSD to read and write any length of data (e.g., even one byte if necessary and up to 4 GB). The SSD 260 of FIG. 2 can process FAST_READS differently from FAST_WRITES in the case the offset is not equal to zero and/or length does not correspond to a multiple number of LBA addresses as the commands will do address transfers that are not an integer multiple of LBA blocks.

In the case of read commands, SSD will need to round up the number of LBAs to one more (e.g., #LBA=(length»12)+1) and then transfer exactly the number of bytes specified in the “length” parameter starting at the “offset” parameter. For example, hardware circuitry of an SSD rounds up the number of LBAs by adding one to the result of dividing the length by 4,096. The SSD then transfers the number of bytes indicated by the value of “length,” starting from the value specified for “offset.” In one embodiment, the read operation is done by using internal memory as a temporary buffer. In one embodiment, the SSD directly sets a DMA operation for the appropriate length of data to be transferred and the remainder of the data is not transferred (e.g., remaining data is sent to null).

In the case of write commands, the operation is more complex as writing under the above conditions requires modifying at least one LBA. In this case, the SSD writes the integer number of LBAs (if any) that corresponds to the data specified for being written. Then, for the LBA for which there is a partial write to perform, the SSD will perform a Read-Modify-Write (e.g., read the LBA block that requires partial modification, modify those bytes as indicated by the length and offset parameters of the command, and write the whole LBA back). For example, a hardware accelerator of the SSD writes the full LBAs. For an LBA that requires a partial write, the SSD performs a Read-Modify-Write operation using the hardware accelerator. This involves reading the LBA for which a portion of data needs modification, updating the specified bytes based on the given length and offset, and then writing the entire data for the LBA back to physical memory (e.g., NAND flash).

Using the above approach, any size of data can be read and written. For example, this provides a useful tool for an inference system that often needs to read sparse data (e.g., data having a few significant elements dispersed in a vast array of irrelevant data). Instead of needing to move all of this data (most of the data is irrelevant), this approach permits transferring only the needed data. This results in faster and cleaner processing. This also has the benefit of reducing or avoiding memory amplification. Memory amplification can occur when significantly more memory is used (e.g., for irrelevant data) rather than just using the needed memory for specific sparse data.

In one example, an SSD reads the entire set of data stored at an LBA address. If the host requests only a portion of the data at the LBA address (sub-block), the SSD reads the entire set of data, and then provides the requested portion to the host. The remaining portion of data is discarded and need not be transferred to the host system. The entire block of data stored at the LBA address is stored as one ECC codeword. To decode the data, the SSD reads the entire codeword.

Regarding the NVMe Data Pointer, the data pointer field of fast commands is modified as compared to normal commands, as described below. The above changes in the length field are used with the modifications to the data pointer. In one embodiment, the data pointer can be modified in two ways (that can coexist with one another), which are described below.

PRP and SGL can be useful features for current and simpler systems, but are complex to manage and largely an unnecessary burden for high-end systems. For example, a system is often addressing memory (e.g., DRAM) that can have sizes measured in terabytes (TB), but the system is required to use memory in chunks of 4 KB pages. Managing linked lists of 4 KB pages to build buffers is becoming increasingly difficult as memory sizes grow. This is particularly so because searching for appropriate blocks grows in complexity with memory size.

In some embodiments, new fast commands take advantage of Linux Folios. Linux has evolved and starting from kernel 6.13 released in late 2024, Linux supports a new feature called “Folios”. For example, Folios relate to sequential 4 KB pages that are used to compose a larger sequential entity called a Folio. One motivation for using Folios is that an operating system (OS) can more readily handle larger pages (e.g., Folios in this case). An advantage is that hardware acceleration can still be based on, for example, 4 KB pages (e.g., ARM processors can support 64 KB pages). Folios benefit from creating large buffers (e.g., up to 64 KB or larger) of sequential memory addresses.

In light of the above advantages, instead of using PRP and SGL, in some embodiments a system uses Folios (e.g., contiguous Folios) up to their limit size. Commands accessing data of a size larger than a Folio limit size (e.g., now 64 KB, but 256 KB and 1 MB expected in the future) can split commands into Folio-sized commands. For example, splitting commands does not necessarily negatively impact performance even though the perception may be that a single large command is more efficient to handle than two smaller commands. But this is not always the case. If a single command has to use PRP and SGL, this creates significant management overhead. Also, if a command needs large resources to be available, the resources may not become available at the same time as needed by the command. Thus, smaller commands may sometimes provide efficiency.

For example, smaller commands can begin execution when their own set of resources are available and do not need to wait for all resources to become available. For example, a 128 KB operation for a first command requires 128 KB of memory. The probability is that an SSD may only identify a smaller amount of free memory, for example 96 KB, when the SSD it receives the command. So, the SSD can either wait for the other 32 KB of memory to become available (such as would be needed by a single large command), or issue a 64 KB command while waiting for the 32 KB to become available and then issue the second command.

In one embodiment, the data pointer for fast commands is modified as compared to normal commands in two ways (that can coexist with one another). These ways are referred to below as Method 1 and Method 2.

In Method 1, fast commands use a physical address. In one example, the address is a system physical address. In one example, the address is a virtual machine physical address. For example, every time an SSD needs to do a DMA transfer of data, one or more addresses need to be translated from a virtual machine address to a system physical address. This requires processing time including going through an IO MMU for translation. In addition, if the DMA transfer is Peer-to-Peer (P2P), this also unnecessarily consumes bandwidth of the Root Complex. Doing the translation before the data transfer occurs (e.g., as discussed below) allows parallelization of operation and time savings when the transfer is actually done.

In Method 1, similarly to current NVMe, an address is inserted in Dword 6:7 and executes as done for current NVMe commands. Because PRP and SGL are not used, Dword 8-9 is unused. This approach provides backward compatibility with existing NVMe standards. A difference from existing NVMe commands is that only a single address is used in the fast commands.

In Method 2, fast commands use a Buffer ID. In one embodiment, when a host system desires to use a buffer identifier (e.g., Buffer ID), the host system generates a command by writing 0x0 in Dword 6-7. This is an illegal system address, so the SSD knows that the address in Dword 6-7 is implicitly not valid (hence determining the SSD is not to process the command using Method 1). Instead, the SSD knows to use the identifier (ID) of the buffer specified in Dword 8-9. As a result, the SSD executes the command by using the address that has been loaded in the table at the address identified by the identifier (ID).

Some embodiments disclosed herein include the use of fixed buffers for data transfer. Runtime management of Folios, by freeing them up and configuring them for each IO, is an expensive and tedious operation. Also, buffers are often (but not always) used as temporary storage (e.g., a page cache) to store data to be moved to a final destination (e.g., storage or another memory address). Creating new buffers for every IO for this purpose is both expensive and unnecessary, so many systems simply configure all the buffers needed at boot time and then reuse them as needed. This approach is already largely used today by many OS/Apps. In one example, the same approach can be extended with a fixed buffer pointing to the entire GPU HBM memory range. Given that HBM memory addresses are static, the buffers that point to these addresses can also be static.

Method 2 can be used to extend this static mapping to SSD operation, thus saving time for buffer management chores. In one embodiment, a system creates buffers as done for contiguous Folios and preloads addresses of the buffers in internal memory of the SSD. For example, if each address is up to 8 bytes in size, even for say 100,000 addresses, this uses no more than 1 MB of SSD memory. For example, this SSD memory does not need to be fast memory or non-volatile memory. Any DRAM space will suffice.

In one embodiment, to address the buffers, the buffers are put in a table with a Buffer ID that indicates the address for that respective buffer. In one embodiment, the length of each buffer is fixed (the IO size is variable, as long as it fits in the buffer). In one embodiment, the length of each buffer is variable. The host system ensures that the buffer is sufficiently large for any command issued by the host system that uses the buffer.

One advantage of the above method results from high-end systems having addresses that are virtualized. For example, the address sent to an SSD may not be a real physical address, but instead need to be translated by an IO memory management unit (MMU) (e.g., using ATS services) before being used. If the target address is for a peer device (e.g., a NIC for a DMA on a remote node), all of these translations may generate extra traffic that burdens the PCIe interface.

Instead, if addresses for the buffers are preloaded, the SSD can use ATS to preemptively perform all necessary virtual-physical translation, cache the address, and perform any other validity check. Thus, when an IO using that buffer ID is invoked, the DMA processing is simpler and does not require further translation or validation. Moreover, this preparation can be done offline at system setup and generally will not change (unless some addresses are invalidated). Generally, such invalidate commands are infrequent, so their impact on performance is minimal. In contrast, the negative impact of continuous translation for Method 1 is significant.

Both Method 1 and Method 2 can be used to accomplish similar results with different tradeoffs (e.g., Method 1 is more flexible, while Method 2 is more performant). Method 1 and Method 2 can also coexist with the existing address approach of existing NVMe Read and Write commands. Hence, usually it is high-performance IO (most likely the majority of commands in such systems) that will use these new methods.

In some embodiments, steering tags are used for transferring data. In one embodiment, the steering tags are used with either Method 1 or Method 2 above. For example, the PCIe Steering Tag is used to direct data to the correct target memory. The steering tag is used to make cache coherency and data delivery more efficient. The PCIe SIG has defined a mechanism, called a Steering Tag, that is used. The PCIe SIG has not codified its usage. So, the steering tag provides available bits that can be used (with no prior definition of their use).

In one embodiment, values are defined for delivery to GPU HBM and other relevant memory locations. For example, if there is a need to move data to a memory target on a coherent domain, the data are generally transferred to main memory and then to target memory to keep the coherency model working. The Steering Tag can be used to indicate to a memory sub-system to deliver the data to the final destination (e.g., GPU memory). This bypasses the intermediate main memory step and invalidates all other entries accordingly. This saves time, bandwidth, and resources.

For example, in a cache coherency protocol, when a cache entity becomes the owner of data, the cache entity sends a message to memory and all peer devices telling them the cache entity now owns the data so the memory and peer devices should invalidate their own copy (if any) of the data.

In one example of existing NVMe data transfer, sending data from an SSD to a cache on GPU3 uses the following steps:
Data are sent by SSD to target memory address
Memory gets hold of the data (data is written in system memory (e.g., DRAM), which becomes the current owner of the data)
All caches, including GPU3, invalidate the data they may have at that address
GPU3 fetches the new data from memory
All caches are updated to reflect new ownership
Processing on data can start

With use of the Steering Tag used as described herein, the processing flow is performed as follows:
Data are sent to GPU3
All caches, including memory, are updated
Processing on data can start

The flow using the Steering Tag is more efficient, and the data are moved only once (e.g., SSD to GPU3) rather than twice (e.g., SSD to memory and then memory to GPU3). The above flow using the Steering Tag is compatible with PCIe specifications.

In one embodiment, a new usage model is defined for the Steering Tag mechanism. This model uses the Reserved configuration bits of the PCIe TLP packet. These three configuration bits are used in the PCIe TLP packet (basically the PCIe transfer packet), and are reserved for the Steering Tag.

In one embodiment regarding Dword 13:15, all data options are removed and not used in fast commands. In one embodiment, if data used in these fields for normal commands is a part of metadata, the data is moved to identify namespace attributes at the time of namespace creation (e.g., as discussed above).

Although the fields for Dword 13:15 are not used for fast commands, these fields are retained to match the command byte count of 64 as is done in all NVMe commands sent by a host system.

In one embodiment, completion processing is improved by use of the data Steering Tag of the response buffer (making delivery more efficient), as described above. For example, there are two types of data a Read/Write command accesses: data buffers and a command/completion queue. The data may be on different processing cores, so the Steering Tags for data in buffers may be different than the Steering Tags for data in queues. For example, data can be in GPU memory and in queues on CPU cores. Data for transfer to either location can use this Steering Tag approach.

In some embodiments, a host system uses fast commands that are not compatible with the NVMe standard. This approach can provide a non-NVMe command set. The approaches described above for fast commands do not rely on NVMe for any specific reason. For example, a new interface can use a different delivery mechanism. Fields used for NVMe could be replaced with corresponding new values in new fast commands.

For example, if a new method uses LUN instead of namespace (NS), the method can substitute values in this field. If direct mapping to storage is used, then NS=0. If the method is using LBAs of different size, this will be transparent to the SSD. If the method is not using LBAs, but instead uses direct page access, the LBA is replaced in a fast command with the page number, size length, and offset.

In one embodiment, a global address-based command ID is used. Given that the number of core threads keeps growing at an accelerated rate, it is difficult for an SSD to match the number of core threads with the number of Queue Pairs (QPs). As a result, GPU threads need to share a common SSD QP, which is undesirable. Fast commands as discussed herein can be used to address this issue, which is a common challenge in NVMe and many other interfaces.

The challenge above results from commands having a “Command ID” identifier (e.g., a unique number that is used to identify the command and associate it in the Completion Queue). In NVMe systems, the command ID is a progressive number that simply rolls over when a limit is reached.

More specifically, to enqueue a command, a thread needs to get a command ID. The thread needs to ensure no other core that is sharing the same queue uses the same command ID. The thread does this by locking the Command ID count, getting the next Command ID, and then releasing the lock. This is detrimental to performance if done across multiple cores (and also possibly done in multiple nodes).

In some embodiments, instead of using a progressive lock as described above, a command uses the Global Address of the memory buffer that the command (e.g., fast read or write command) is currently using (e.g., the memory address). The Global Address is a unique number as no two threads can perform read/write operations using the same buffer. The Global Address needs to be global (e.g., by using the node identifier). For example, if the threads run on different nodes, the threads may have a same lock buffer address, which is made unique if the node ID identifier is added. This avoids any inter-core communication for acquiring and releasing locks.

In one embodiment, fast commands use buffer identifier (e.g., Buffer ID) addressing as described herein. In this case, the fast command uses the Buffer ID as the Command ID (because the Buffer ID is already unique). This approach can be simpler, faster, and/or more compact. The Buffer ID will only be released when the command is complete, so there is no risk of aliasing or duplications.

In one embodiment, atomic enqueuing is used. When a command is moved to the command queue (e.g., submission queue), there is a need to ensure that no two threads are writing to the same command queue. Otherwise, the result may be an improper piecemeal combination of the two commands. In existing NVMe systems, this problem is avoided similarly as above (e.g., lock the queue, write a command to the queue, then release the queue). This approach can cause similar limitations as above.

Due to use of the Global address-based Command ID in a command as discussed above, there is no other dependency of the command from other commands. The submission queue is left unlocked so other commands can operate on it. A thread prepares a command in a scratchpad area (e.g., temporary cache or other memory of a host system). Once the command is prepared and ready, the thread moves the command to the submission queue using an atomic write (e.g., an existing x86 write operation that guarantees that data are moved into the queue in a single shot). This avoids any other thread being able to write to the submission queue while the command is moved.

In one embodiment, a command can be used to identify values of parameters shared by a set of commands for fast processing. The command can be used to provide some or all metadata parameters as attributes of a namespace to be accessed by the set of commands for fast processing.

In some cases, a host system may issue a normal read/write command with metadata parameters specified in the command, but the metadata parameters can be incompatible with the attributes specified for the namespace being accessed by the normal read/write command. Such a read/write command is processed using firmware. A controller of the solid-state drive 260 executing such a normal read/write command can check the metadata parameters in the command, and verify whether the metadata parameters of the command are compatible with the attributes currently set for the namespace being accessed by the command. If not compatible, the controller can reject the read/write command.

In one embodiment, a host configures a read or write command to pin the data read from or written to the storage space of the SSD 260 in a cache memory (e.g., a portion of the memory 280 of the SSD 260). For example, the data is a block of data retrieved from the storage space of the SSD 260 in response to a read command from the host to retrieve a sub-block of a block at an LBA address, which can be subsequently updated by the host during AI processing. Once the data of the entire block is pinned in the cache memory, a subsequent command operating on the LBA address can reuse the cached data without having to read it from the LBA address again.

For example, a read command can be configured with an option field (e.g., in a reserved or unused bit segment of the command). A predefined value can be specified in the field to indicate that data read from an LBA address be pinned. Subsequent commands operating on the LBA address can use the pinned data in the cache memory (e.g., a portion of the memory 280). For example, a subsequent write command to a sub-block does not have to read the data again from the storage media at the LBA address. Instead, the write command can modify the data in the cache memory and then write the modified data to the storage space at the LBA address.

Various types of commands can be configured to pin data. For example, a read/write fast command can be configured with a field at predefined bit segments of the fast command to provide a parameter that when having a predefined value causes the SSD to pin data being read from or written to the storage space of the SSD 260. For example, a normal read command can use a reserved field to indicate the request to pin. For example, a new command can use an opcode that represents read and pin. A pin option can be indicated by a newly configured option field (e.g., as an attribute of a namespace). Optionally, a command can be used to cause a “pin to cache” mode of the SSD to persist over more than one read/write command (e.g., multiple subsequent read/write commands will have data pinned to the memory of the SSD 260); and another command can be used to turn off the “pin to cache” mode.

In some cases, a write command can be configured to pin the data being written to the storage space of the SSD 260 to the memory 280 of the SSD 260. Optionally, a write command can have an option instruct the SSD 260 to write only to the pinned/cached version of data (e.g., this can delay writing the data to NAND storage media).

In one embodiment, a memory sub-system (e.g., SSD 260) supports sub-block reads and writes. In one example, the size of the sub-block is as low as a single byte (1 B). In one example, the size of the sub-block is 8 B-128 B.

When doing a write, a “Read Modify Write” operation is needed for a block at the target LBA address. The entire data in the block is to be written as a whole. For example, if a write command modifies 128 B out of total 4 KB of the block, the entire 4 KB is read/retrieved from the storage space, the requested 128 B modified, and the entire new 4 KB of data written back to the storage space at the target LBA address. The implication is that a single sub-block read is a single operation on the backend (e.g., a read at the SSD), while a single sub-block write is typically two operations (e.g., a read and a write at the SSD), which causes reduced performance when the read can be avoided in some situations.

In one example, sub-block writes are updates of reference parameters. The old value of the parameter is read, operated on, and updated with new value. For example, a read modify write is required for a sub-block size of 128 B or other size read. The read modify write is done at the LBA address level when the host system writes the new value back to the memory sub-system.

In one embodiment, a parameter is included in a fast command that causes read data to be pinned to a cache of an SSD. The pinned data is retained in the cache for use by the SSD when processing one or more subsequent commands. For example, a host GPU uses this feature of “pinning to cache” when the GPU is to update the reference parameters extracted from the sub-block. The fast read command used to get the reference parameters to be updated tells the SSD to keep the read data in its cache memory (e.g., as far and as long as there is cache memory available). Then, when the GPU uses a fast write command to store the updated reference parameters back to the sub-block, the SSD already has the read data in its cache. This eliminates a read step from the read modify write operation discussed above.

In one example of an existing approach without using the feature of “pin to cache”, to update a reference parameter:
GPU reads the 128B or other size data from an LBA at an SSD
GPU updates the read data
GPU sends new 128B data to SSD for writing to the LBA
SSD reads back old data at the LBA
SSD modifies the old data with the new data
SSD writes modified data back to the LBA

In one example of a new approach using the feature of “pin to cache”, to update a reference parameter:
GPU reads the 128B or appropriate size data at an LBA. The read command causes an SSD to pin read data to cache (so the SSD is directed to keep a copy).
GPU updates the read data
GPU sends new 128B data to SSD for writing
There is no need to read back old data at that LBA as data is already in cache.
SSD modifies the old data pinned in the cache with the new data from the GPU
SSD writes modified data back to the LBA

The above pinning of data to cache removes a read operation, so that the number of operations is reduced from three to two (only modify and write).

In one example, an SSD retrieves commands from a submission queue of a host system. Each command specifies an LBA address from which data is retrieved. The retrieved data is transferred to a memory address of host system memory that is specified in the command.

In one example, each command is configured according to a non-volatile memory express (NVMe) standard. Each NVMe command indicates one or more functions to be performed by the SSD (e.g., to read from a storage space of the SSD, to write to the storage space, etc.). The processor identifies read/write locations in the commands using logical block addressing (LBA) addresses. The SSD has a flash translation layer to map/translate the LBA addresses to physical addresses in flash memory of the SSD.

For example, each NVMe command further includes information about the location in the storage space for the operation, a location in main memory to store the retrieved data for a read, and/or a location in main memory to retrieve the data to be written into the SSD. A PCIe bus/physical connection used for accessing memory. The SSD accesses the main memory over the PCIe bus.

In one embodiment, a memory sub-system is an NVMe SSD. The NVMe SSD implements the NVMe interface using QPs as defined in the NVMe specification 2.0.

In one embodiment, a host system and memory sub-system communicate over a connection fabric. In one example, the connection fabric is a PCIe fabric and includes a root complex. For example, the root complex can be implemented by hardware of the host system, or can be implemented on a separate chip.

The connection fabric enables the host system and memory sub-system to access main memory of the host system. In one example, a controller performs direct memory access (DMA) operations on the main memory in response to commands received from the host system.

In one embodiment, a host system sends commands using transaction layer packets (e.g., TLPs according to a PCIe protocol). Each TLP can include a command (e.g., normal and/or fast command). In one example, the command is included as part of a work request encapsulated by the TLP. For example, the normal and/or fast commands are retrieved by an SSD via a submission queue. Corresponding completion records are received by a completion queue.

In one embodiment, a controller of the SSD copies commands to an internal command queue in response to receiving a transaction layer packet. In one embodiment, the command(s) of the TLP are stored in the command queue without any dependency on other transaction layer packets received from the host system. In one embodiment, multiple work requests can be delivered to the memory sub-system using a single transaction layer packet.

In one example, the connection fabric includes a PCIe bus acting as a bridge connecting a host system and an SSD. When the host system writes to memory in the SSD over the PCIe bus, PCIe TLPs are used. When the SSD reads or writes memory on the host side (e.g., to retrieve commands for a submission queue, or to enter a completion record in a completion queue), the SSD also uses PCIe TLPs.

In one example, a host system includes one or more cores. Each core executes one or more threads during training of one or more neural networks. During the training of the neural networks, various weights used in the training can be stored in a non-volatile memory device of an SSD in response to commands generated by one or more threads. Weights can also be read from the non-volatile memory device in response to commands generated by one or more threads.

In one example, an access request can be implemented according to the an access command having a predetermined command size (e.g., 64 bytes according to a version of NVMe standard). The access command can have a plurality of predefined fields, such as opcode, namespace identifier, LBA address, metadata pointer, data pointer, etc. For example, the predefined fields can be in compliance with a version of NVMe standard (e.g., base specification version 2.0). The opcode can be configured to specify whether the command is to be executed to read data or to write data.

In one embodiment, the opcode can be configured to specify whether the command is to be executed as a normal or a fast command (e.g., to read data or to write data.

In one embodiment, the namespace identifier can be configured to specify a namespace for the interpretation of the LBA address. The LBA address identifies, in the namespace, a logical block having the predefined logical block size (e.g., 512 bytes, or larger). The metadata pointer can be configured to provide an address of a physical buffer of metadata. The data pointer can be configured to provide an entry used for data transfer, such as an entry to facilitate data transfer via physical region page (PRP).

In one embodiment, a memory sub-system retrieves commands (e.g., normal and/or fast commands) from a submission queue of a host system. The submission queue and completion queue are a queue pair (QP). A controller periodically checks to see if a command is present in submission queue (or a doorbell register is used). If so, the controller reads the command from the submission queue, executes the command, and generates a completion record that is sent to the completion queue.

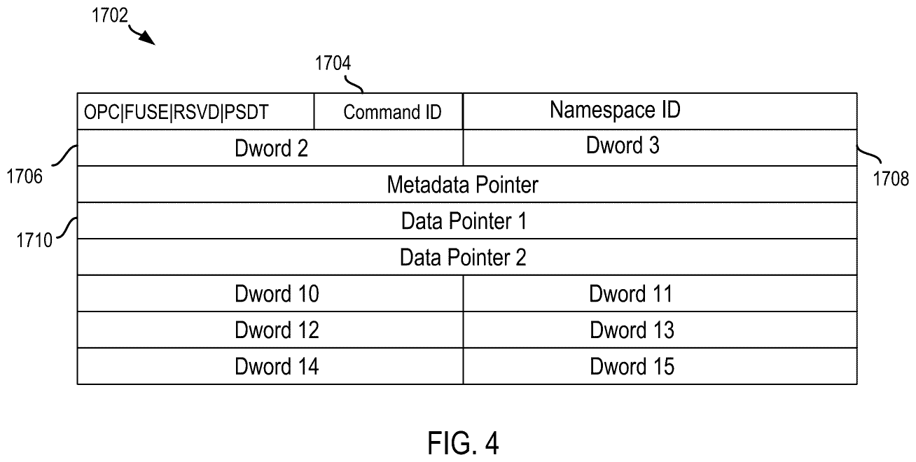

FIG. 4 shows a format of a read or write command 1702 (e.g., normal commands 282) received via a submission queue (e.g., in accordance with a current standard for non-volatile memory express (NVMe). The command 1702 includes various predefined fields to instruct a memory sub-system (e.g., 101 or SSD 260) to read data from, or write data to, a storage space 261 at a location identified via parameters embedded in the command 1702.

The command 1702 has a fixed size of 512 bits (64 bytes, or 16 double words). For convenience in referencing, the 512 bits of the command 1702 are partitioned into 16 segments of bits such that each of the 16 segments has 32 bits (or 4 bytes) and can be referred to as a Command Dword (double word) (or simply Dword). The 16 segments can be numbered as Command Dword 0 to Command Dword 15.

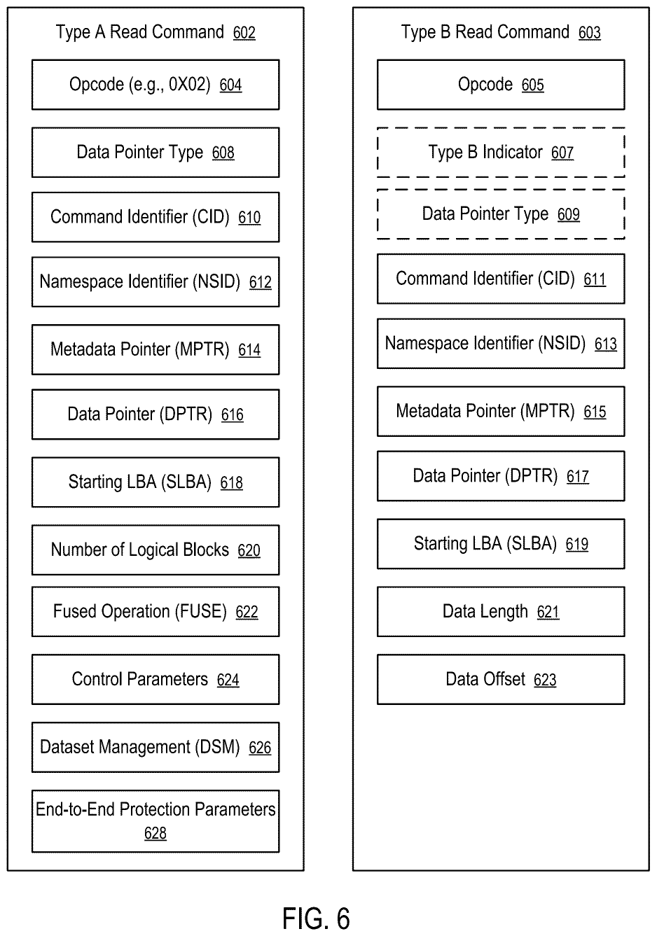

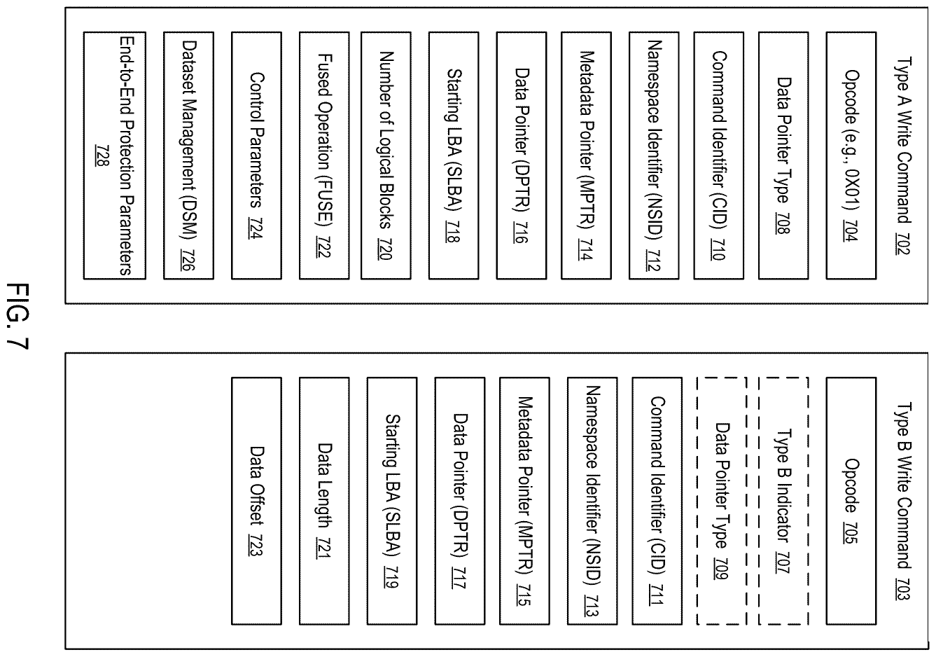

For example, the command 1702 includes a field 1704 configured in bits 31:16 of Dword 0 to carry a Command Identifier (CID or Command ID) of the command. The command 1702 includes a field configured in bits 15:14 of Dword 0 to carry a parameter PSDT (PRP or SGL for Data Transfer) configured to indicate whether Physical Region Pages (PRPs) or Scatter Gather Lists (SGLs) are used for any data transfer associated with the command. The command 1702 includes a field configured in bits 9:8 of Dword 0 to carry a parameter Fused Operation (FUSE) configured to specify whether the command is part of a fused operation and if so, which command it is in the sequence. The command 1702 includes a field configured in bits 7:0 of Dword 0 to carry a parameter Opcode (OPC) configured to identify a predefined type of operation of the command. For example, when the command has an opcode value of 0x01, the command 1702 is a write command; and when the command has an opcode value of 0x02, the command 1702 is a read command. For example, the bits 13:10 of Dword 0 are reserved in a current standard of NVMe and thus considered a reserved field (RSVD); and the entire set of 32 bits (4 bytes) of Command Dword 1 is used to identify a Namespace Identifier (NSID or Namespace ID) of a namespace to which the command is to be applied to. When the command 1702 is a read or write command, Dwords 2 and 3 (1706, 1708) are used to host parameters of Expected Logical Block Storage Tag (ELBST) and Expected Initial Logical Block Reference Tag (EILBRT) related to end-to-end protection. The command 1702 includes a metadata pointer field configured in Dwords 4 and 5 and a data pointer field 1710 configured in Dwords 6-9, along with other various fields (e.g., as further discussed in connection with FIG. 6 and FIG. 7).

In one example, the end-to-end protection parameters embedded in Dwords 2 and 3 of a normal command 282 are not extracted from a fast command 284. Thus, Dwords 2 and 3 of a fast command 284 can be ignored, or repurposed to provide other parameters of interest in the execution of the fast command 284. Dwords 10 and 11 are combined to host a “Starting LBA” field for a normal read/write command 282 and for a fast command 284. Dword 12 is configured to provide control parameters (e.g., Limited Retry (LR), Force Unit Access (FUA), Protection Information Field (PRINFO), Storage Tag Check (STC)) and “Number of Logical Blocks (NLB)” in a normal read/write command 282 can be repurposed to “data length” in a fast command 284.

In one example, the definitions of the fields in a normal command 282 are in accordance with a current standard of NVMe (e.g., NVM Express NVM Command Set Specification, Revision 1.1 of Aug. 5, 2024; and NVM Express Base Specification, Revision 2.1 of Aug. 5, 2024, the contents of which are hereby incorporated herein by reference).

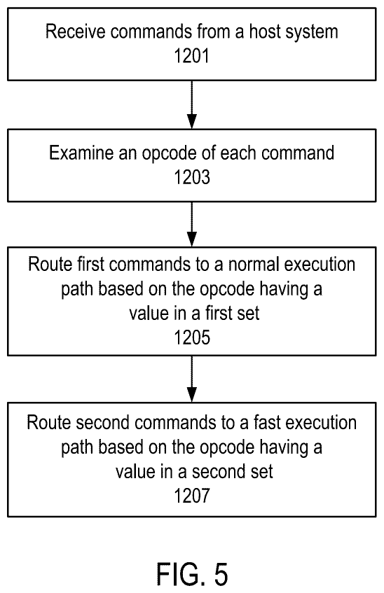

FIG. 5 shows a method for configuring read or write commands to indicate selection of either a normal or fast execution path for processing each command according to one embodiment. The method of FIG. 5 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 5 is performed at least in part by the processing device 118 of the host system 102, the controller 115 of the memory sub-system 101, and/or the local media controller 105 of the memory sub-system 101 in FIG. 1.

Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 5 can be implemented using the firmware 113 of FIG. 1 to perform the operations illustrated in FIGS. 2-4.

At block 1201 in FIG. 5, commands are received from a host system. The commands include first and second read/write commands of different types (e.g., normal and fast). In one example, the first commands are normal commands 282. In one example, the second commands are fast commands 284.

At block 1203, an opcode of each command is examined. In one example, the opcode is located in Dword 0 of an NVMe command. In one example, the opcode indicates the command is a fast command 332.

At block 1205, the first commands are routed to a normal execution path based on the opcode having a value in a first set. In one example, normal commands 282 are routed to a processing path that includes firmware-based resources 290 and hardware circuitry 292. In one example, the first set includes one or more values that indicate a type of normal processing to be used for a command.

At block 1207, the second commands are routed to a fast execution path based on the opcode having a value in a second set. In one example, fast commands 284 are routed to a processing path that includes hardware circuitry 292, but does not include firmware-based resources 290. In one example, the second set includes one or more values that indicate a type of accelerated processing to be used for command. For example, an SSD can have multiple different fast execution paths. The particular path to be used is indicated by the value in the second set.

In some aspects, the techniques described herein relate to a memory sub-system (e.g., solid-state drive 260) including: a host interface configured to receive first commands (e.g., normal NVMe commands 282) and second commands (e.g., fast NVMe commands 284), each command having a first field and a second field; and at least one controller (e.g., 115, 294) configured to process the first commands using a first mode (e.g., normal mode) in which the first and second fields are processed, and the second commands using a second mode (e.g., fast mode) in which the first field is processed and the second field is ignored.

In some aspects, the techniques described herein relate to a memory sub-system, wherein each of the first and second commands includes an opcode (e.g., indicating a normal NVMe read execution path or a fast read execution path), and the controller is further configured to select either the first or second mode for handling a received command based on the opcode. For example, if the opcode is for a read command, the command is processed in a read command processing mode; and if the opcode is for a write command (or another command), the command is processed in a write command (or other command) processing mode.

In some aspects, the techniques described herein relate to a memory sub-system, wherein the first field (e.g., Dword 6-7) includes a data pointer and the second field (e.g., Dword 13-15) includes at least one control parameter (e.g., metadata control parameters).

In some aspects, the techniques described herein relate to a memory sub-system, wherein the first field (e.g., Dword 10-11) includes a starting LBA address, and the second field includes fused operation bits.

In one example, if the standard opcode for normal NVMe read is specified in a command, the memory sub-system evaluates a field of “fused operation bits” in a particular segment location of Dwords of the command. When the new opcode for a fast read is specified in a command, the bits at this same segment location have no meaning by definition (and thus are not processed by the memory sub-system). In other embodiments, the meaning of data located in certain field(s) (e.g., predefined Dword, byte, and/or bit locations) of a normal command are redefined for the same field(s) in fast commands.

In some aspects, the techniques described herein relate to a memory sub-system, wherein the first field is processed in the first and second modes using hardware circuitry (e.g., 292).

In some aspects, the techniques described herein relate to a memory sub-system, wherein the second field is processed in the first mode at least in part using firmware (e.g., firmware-based resources 290).

In some aspects, the techniques described herein relate to a memory sub-system, wherein the first field (e.g., Dword 6-9) is configured for the first commands to include a data pointer, and configured for the second commands to include either a data pointer (e.g., in Dword 6-7) or a buffer identifier (e.g., buffer ID in Dword 8-9).

In some aspects, the techniques described herein relate to a memory sub-system, wherein the first field (e.g., Dword 12) when used in the first commands includes a number of LBA addresses to read, and when used in the second commands includes a length of consecutive bytes to read.

In some aspects, the techniques described herein relate to a memory sub-system, wherein the first field (e.g., Dword 13) when used in the first commands includes one or more command-specific parameters, and when used in the second commands includes an offset from a first LBA address to access as part of a read or write operation.

In some aspects, the techniques described herein relate to a memory sub-system, wherein each of the first and second commands includes an indication of a command type (e.g., a value in a vendor-specific field or a reserved field of a received command that indicates to use either a normal read/write execution path, or a fast read/write execution path), and the controller is further configured to select either the first or second mode based on the indication.

For example, the command type (e.g., read, write, fast read, fast write) is defined by the value in the opcode field of an NVMe 64-byte command structure. The opcode field is in the same location for both normal and fast commands. A same field (as defined by a size and location in the Dwords of a command) can have no meaning in one type of command as defined by an opcode field, and be necessary or essential for another type of command as defined by the opcode field. In some cases, the same fields can be partitioned/defined differently within the Dwords for normal and fast commands.

In some aspects, the techniques described herein relate to a memory sub-system including: a host interface configured to receive read or write commands, wherein each command has a predefined size (e.g., 64 bytes); and at least one controller configured to operate in a first mode (e.g., normal mode) in which a first portion of the received commands are processed using firmware, and in a second mode (e.g., fast mode) in which a second portion of the received commands are processed without using firmware.

In some aspects, the techniques described herein relate to a memory sub-system, wherein each command has a same size (e.g., 64 bytes arranged as 16 Dwords that are 4 bytes wide).

In some aspects, the techniques described herein relate to a memory sub-system, wherein each command includes an indication (e.g., an opcode or a value in a different field of the command) used by the controller to select the first or second mode for processing the command.

In some aspects, the techniques described herein relate to a memory sub-system, wherein each command includes fields, and the fields to be processed by the controller are selected based on the indication.

In some aspects, the techniques described herein relate to a memory sub-system, wherein each command includes a first field, and the controller interprets the first field in a different way for each of the first and second modes.

In some aspects, the techniques described herein relate to a memory sub-system, wherein the first field (e.g., Dword 13) when processed in the first mode is interpreted to include one or more command-specific parameters, and when processed in the second mode is interpreted to include an offset from an LBA address.

In some aspects, the techniques described herein relate to a memory sub-system, wherein the controller is further configured to select either the first mode or second mode for operation based a predefined parameter in a command received from a host system.

In some aspects, the techniques described herein relate to a memory sub-system, wherein the controller is further configured to: examine a field of a first command; and send, based on examining the field, the first command to either a queue for firmware processing, or a hardware acceleration path.

In some aspects, the techniques described herein relate to a memory sub-system, wherein the commands are configured to be compatible with a protocol for non-volatile memory access (e.g., NVMe standard).

In some aspects, the techniques described herein relate to a memory sub-system, further including at least one non-volatile memory device, wherein the controller (e.g., 250) is further configured to: receive, from a submission queue of a host system, a first command configured with a predefined field, wherein the predefined field includes a command identifier.

In some aspects, the techniques described herein relate to a memory sub-system, wherein the controller is further configured to receive, via the host interface, a first command configured to determine whether the second mode is supported.

In some aspects, the techniques described herein relate to a memory sub-system, wherein the controller is further configured to send, in reply to the first command, a response indicating that the second mode is supported.

In some aspects, the techniques described herein relate to a memory sub-system, wherein the controller is further configured to change operation from the first mode to the second mode in response to receiving a second command from a host system.

In some aspects, the techniques described herein relate to a memory sub-system including: memory configured to receive commands each having first and second fields; and at least one controller configured to operate in a first mode (e.g., normal mode) in which the first and second fields are processed, and in a second mode (e.g., fast mode) in which the first fields are processed and the second fields are ignored.

In some aspects, the techniques described herein relate to a memory sub-system, wherein the controller is further configured to: when operating in the first mode, execute firmware to examine the second fields for parameters; and if at least one parameter is provided, process the parameter according to a standard (e.g., NVMe standard) for communications between memory sub-systems and host systems.

In some aspects, the techniques described herein relate to a memory sub-system, wherein the controller is further configured to select either the first mode or second mode for operation based on examining a field in a command received from a host system.

In some aspects, the techniques described herein relate to a memory sub-system, wherein the commands request a read or write operation, and the second fields include parameters that are not necessary for completing the read or write operation (e.g., command parameters in the NVMe standard such as fused operation parameters in Command Dword 0, and/or parameters in Command Dword 13-15).

In some aspects, the techniques described herein relate to a memory sub-system, wherein the first fields include an LBA address (e.g., starting LBA) and a data pointer, and the second fields include optional control parameters.

In some aspects, the techniques described herein relate to a memory sub-system, wherein the second fields include fused operation parameters.

In some aspects, the techniques described herein relate to a memory sub-system, wherein each command is configured according to a standard for communications between memory sub-systems and host systems.

In some aspects, the techniques described herein relate to a memory sub-system, wherein the standard is a standard for non-volatile memory express (NVMe).

In some aspects, the techniques described herein relate to a memory sub-system including: firmware-based resources configured to process commands; and at least one controller configured to, in response to receiving an indication from a host system, reduce usage of the firmware-based resources in processing the commands.

In some aspects, the techniques described herein relate to a memory sub-system, wherein the usage of the firmware-based resources is eliminated.

In some aspects, the techniques described herein relate to a memory sub-system, wherein the reducing usage includes ignoring at least one field of the commands.

In some aspects, the techniques described herein relate to a memory sub-system, wherein the indication is included in a command.

In some aspects, the techniques described herein relate to a memory sub-system, wherein the command is a read or write command.

In some aspects, the techniques described herein relate to a memory sub-system, wherein: the command is a first command; the usage of the firmware-based resources is reduced from a first extent of usage to a second extent of usage; and the controller is further configured to, in response to receiving a second command, return the usage of the firmware-based resources to the first extent.

In some aspects, the techniques described herein relate to a memory sub-system, wherein the indication is an opcode in a command.

In some aspects, the techniques described herein relate to a memory sub-system, wherein the indication is at least one field in a command received from the host system.

In some aspects, the techniques described herein relate to a memory sub-system, wherein the indication is provided by a set feature command.

Various embodiments related to NVMe-compatible fast read commands that turn off processing of options for normal NVMe read commands are now discussed below.

In one embodiment, an opcode is used in a fast command to cause a memory sub-system to perform the operations of a normal NVMe read command, except a controller of the memory sub-system ignores a predefined set of fields (e.g., fuse operation parameters in Command Dword 0, and at least some fields in Command Dword 13-15). The fast read command is processed with the assumption by the controller that the fields provide a set of predefined/fixed values, regardless of the actual content in the fields.

In one example, the memory sub-system is memory sub-system 101 or solid-state drive 260.

In one embodiment, the fast read command can have the same content as a standard NVMe read command, except that the standard opcode for a normal read command is replaced with a new opcode that indicates to the controller that the command is a fast command. The new opcode can be used by the host system to instruct the memory sub-system to ignore the predefined set of fields/parameters provided in the standard NVMe read command having the content.

In one embodiment, when the predefined set of fields in an NVMe read command are ignored, the memory sub-system can skip running a set of routines (e.g., firmware-implemented routines) in processing the read command for improved performance.

The size of a block represented by a Logical Block Addressing (LBA) address can be defined via an NVMe command (referred to as “Formatted LBA Size” in NVMe). For example, the block size can be 512 bytes, or 4 KB, or another number. The normal NVMe read command specifies the number of contiguous LBA addresses to be read, which is the multiple of the Formatted LBA Size.

In one embodiment, a fast read command does not specify a data length (e.g., the size of the data to be read from the storage space or written to the storage space) as a number of logical blocks each having the Formatted LBA Size. Instead, the fast command defines a length as a number of consecutive units of data to be read. In one example, the unit of data can be a byte, word, double word, or cacheline (e.g., 128 bytes). In one embodiment, the fast command includes a field predefined at a bit segment in the fast command; and a value specified in the field identifies the unit. In some implementations, the size of the unit is computed from the value (e.g., as 2 to the power of the value). In one example, the length can extend over multiple logical blocks. Also, the range of data represented by the length is not necessarily aligned with a logical block boundary; and an offset from the logical block boundary corresponding to a starting LBA address specified in the command can be specified in a field configured in a predefined bit segment of the command.

In one embodiment, some of the bit locations of Dword 12 can be used to define the unit of data for the length. For example, if a unit field has a value of n, the unit of data is defined as 2\hat{ }n bytes.

In an alternative embodiment, values for the unit of data can be coded to represent commonly used sizes, such as 0 for LBA block size, 1 for byte, 2 for 8-byte, 3 for 128-byte.

In one embodiment, values for the unit of data are specified in another Dword, such as the “Fused Operation” field of Dword 0.

FIG. 6 shows two types (Type A and Type B) of read commands according to one embodiment. For example, the read commands can be retrieved by a controller 115 of a memory sub-system 101 from a submission queue 270 for execution within the memory sub-system 101.

Type A read command 602 carries various parameters in compliance with a current NVMe standard. The parameters define the scope, requirements, resources, etc. of operations to be performed during execution of the command. This command execution includes firmware processing for at least some of the parameters. In one example, read command 602 is a normal command 282.

Type B read command 603 carries various parameters used in command processing by the non-volatile memory sub-system. In some cases, the processing of these commands does not require, or reduces the extent of, firmware processing (e.g., due to elimination of fields used in Type A read command 602). In other cases, the processing of one or more parameters of these commands may use firmware processing. The number of parameters and/or options defined by read command 603 are reduced relative to the number of parameters and/or options defined in read command 602 (e.g., read command 603 does not include dataset management field 626 or end-to-end protection parameters field 628). In some cases, certain parameters and/or options are not included in read command 603 to provide accelerated processing. In one example, read command 603 is a fast command 284.

In one example, read command 602 and read command 603 can be configured, with embedding appropriate parameters in various fields of the commands 602 and 603, to cause a controller 115 of the memory sub-system 101 to perform an identical operation of reading a block of data from non-volatile memory implementing the storage space 261 and loading the block of data to a same memory location in the memory 264 of the host system 102. Although the backend operation is the same in each case, read command 603 has fewer fields than read command 602, or read command 603 skips one or more fields that are processed for read command 602.

Various parameters of Type A read command 602 are now described below. These parameters are indicated by values provided in various defined fields of read command 602.

Opcode field 604 specifies the opcode of the command to be executed. For example, an opcode value of 0x02 can be used in the opcode field to identify the command as a read command according to the NVMe standard. The opcode value is configured in bits 07:00 of command Dword 0.

For example, an opcode in opcode field 604 has 8 bits. Bits 7:2 indicate Function, and bits 1:0 indicate Data Transfer. For example, a value of 10b for bits 1:0 indicates a data transfer for a read. The Function portion of the opcode for read is 0. Thus, the combined opcode (the entire opcode value) is 02h in hexadecimal.

Data pointer type field 608 is configured to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0.

If the PSDT option is set to 01b or 10b (indicates use of SGL), a controller can use Scatter-Gather Lists (SGL) in two ways. For data buffers, SGL enables data transfers by specifying multiple non-contiguous memory locations. For command submission (indirect SGL), SGL entries are stored separately from the command, which avoids command size limitations. When indirect SGL is used, the command only specifies a memory address; and the controller has to fetch further data regarding the SGL from the memory address. In some cases, SGL can be used to specify the accessing of a sub block.

Command identifier field 610 specifies a unique identifier for the read command 602 when combined with the submission queue identifier. This field is configured in bits 31:16 of command Dword 0.

Namespace identifier field 612 specifies the namespace that read command 602 applies to. This field is configured in bytes 07:04 of command Dword 1.

Metadata pointer field 614 is configured to carry a memory address of metadata provided in a way according to the option specified in the data pointer type field for the execution of the read command 602. This field is configured in bytes 23:16 of command Dword 4-5.

Data pointer field 616 specifies the data used in the read command 602. This field is configured in bytes 39:24 of command Dword 6-9.

Starting LBA field 618 indicates the 64-bit address of the first logical block to be read as part of the read operation for read command 602. This field is configured in bits 63:00 of command Dword 10-11.

Number of logical blocks field 620 indicates the number of logical blocks to be read when executing read command 602. This field is configured in bits 15:00 of command Dword 12.

Fused operation field 622 specifies whether read command 602 is part of a fused operation and if so, which command it is in the sequence. This field is configured in bits 09:08 of command Dword 0.

Control parameters field 624 corresponds to the parameters for “Limited Retry (LR)”, “Force Unit Access (FUA)”, “Protection Information Field (PRINFO)”, and “Storage Tag Check (STC)” defined in command Dword 12. “Limited Retry (LR)” indicates whether the controller should apply limited retry efforts when executing the command and is configured in bit 31. “Force Unit Access (FUA)” is a flag configured in bit 30 that, if set, forces the controller to fetch data from non-volatile media (e.g., rather than from any volatile cache). If the flag is set to 1, then data and metadata associated with logical blocks specified by read command 602 is committed to non-volatile media, and the data and metadata read from non-volatile media are returned.

“Protection Information Field (PRINFO)” is configured in bits 29:26 and specifies the protection information action and check field. “Storage Tag Check (STC)” is configured in bit 24 and specifies the Storage Tag field is to be checked as part of end-to-end data protection processing.

Dataset management field 626 indicates attributes for the LBA addresses being read when executing read command 602. The dataset management field 626 is configured in bits 07:00 of command Dword 13. For example, bit 6 “Sequential Request” can be set to inform the controller that this read is part of a sequential stream of reads. Other attributes include indications for access frequency and latency tolerance for the LBA range being read. These attributes can provide guidance to the controller for configuring how it fetches data.

End-to-end protection parameters field 628 corresponds to the parameters defined in Dwords 2, 3, 14, and 15. Bits 47:00 of command Dwords 2-3 and bits 31:00 of command Dword 14 specify the variable sized Expected Logical Block Storage Tag (ELBST) and Expected Initial Logical Block Reference Tag (EILBRT) fields. If the namespace identified in the read command is not formatted to use end-to-end protection information, then these fields are ignored.

The Expected Logical Block Application Tag Mask (ELBATM) field is configured in bits 31:16 of command Dword 15. This field specifies the Application Tag Mask expected value. The Expected Logical Block Application Tag (ELBAT) field is configured in bits 15:00 of command Dword 15. This field specifies the Application Tag expected value. If the namespace identified in the read command is not formatted to use end-to-end protection information, then these fields are ignored.

In one example, NVMe supports an end-to-end data protection feature that can be used to guard against data corruption between the host and the storage space 261 (e.g., NAND flash) of SSD 260. If a namespace is formatted with metadata, these bytes can store a Guard field (CRC), Application Tag, and Reference Tag. The read command's PRINFO and STC fields (configured in command Dword 12) allow the host to specify what integrity checks to perform. The controller can automatically verify the guard CRC on a read and if it detects a mismatch, the controller generates a Guard Check error.

The application tag and reference tag can be used to ensure the data is from the expected location or context (e.g., the reference tag can include the logical block address which the controller compares against the actual LBA, detecting misdirected writes/reads). If the host sets the Storage Tag Check (STC) bit, the controller will also verify the application tag on read. End-to-end protection, when enabled, can improve reliability by detecting corruption that might occur in the read path (e.g., in the PCIe link, or DRAM memory, or within the controller). In one example, read commands and data transfers are protected by PCIe's Link-layer CRC and memory ECC (if the host's memory or the SSD's buffers have ECC).

Various parameters of Type B read command 603 are now described below. These parameters are indicated by values provided in various defined fields of read command 603.

Opcode field 605 specifies the opcode of the command to be executed. The opcode value can be configured in bits 07:00 of command Dword 0 (same location as for read command 602) for compatibility with the NVMe standard, or can be configured in another bit segment or location of the command. For example, the value of the opcode can indicate that the command is a fast command 284.

In one embodiment, a new opcode is defined for Type B read command 603. For example, the opcode can be a vendor specific opcode for I/O commands (in the range of 80h to FFh). For example, a value of 0x82 can be used to provide a fast vendor specific read command that is in compliance with the NVMe standard for vendor specific extensions.

Optionally, read command 603 is configured to further include a Type B indicator 607 configured to indicate to the controller whether the command 603 containing the Type B indicator 607 is to be processed to have the fields as defined for Type B read command 603. For example, Type B indicator 607 can be a single-bit field configured in a bit segment that is reserved in a read command according to a current NVMe standard. When a first value (e.g., “1”), is specified in Type B indicator 607, the controller 115 of the memory sub-system 101 can recognize the command 203 as a “Type B” read command having the fields as configured in a way different from the “Type A” read command 602, even when the same opcode “0x02” is used in the command 603. When a “Type B indicator 607” is used to differentiate a “Type A” read command 602 and a “Type B” read command 603, the use of the “Type A” command 602 is to be modified to also include the field of “Type B indicator 607” at the same single-bit field that is reserved in a current NVMe standard; and when a second value (e.g., “0”) is specified in the field, the memory sub-system 101 can recognize that the command is a “Type A” command 602 having fields as defined differently from the “Type B command 603”. Alternatively, whether a read command is a “Type A” read command 602 or a “Type B” read command 603 is based on the use of different opcodes in the opcode fields. In one embodiment, Type B indicator 607 is configured to indicate that the command 603 containing it is a “Type B command 603” based on a specific value provided in a field that is also defined in the “Type A command 602” where the meaning of the specific value in the field is reserved according to a current NVMe standard so that the controller interprets the presence of the specific value in the field is an indication that the retrieved command 603 is to be interpreted in a way as illustrated for the Type B read command 603, different from the field definitions of Type A read command 602. In some implementations, a memory sub-system 101 is configured to support the “Type B” read command 603 without supporting the Type A read command 602 that is in compliance with a current NVMe standard. In such implementations, it can be unnecessary to have a “Type B indicator 607”, and the same opcode 0x02 currently used for “Type A” read command 602 can be reused as the opcode for “Type B” read command 603.

In one embodiment, the value of the opcode provided in opcode field 605 can be the same (e.g., 0x02) as used in opcode field 604, and a command is indicated as being a Type B read command 603 (e.g., a fast command 284) in another way such as including a flag in another bit segment (e.g., in Dword 14 or 15) of the command.

In one embodiment, the value of the opcode provided in opcode field 605 can be the same (e.g., 0x02) as used in opcode field 604, and a command is indicated as being a Type B read command 603 (e.g., a fast command 284) in another way based on a mode of operation of a controller or a non-volatile memory system. In this case, Type B indicator 607 is not required in read command 603 itself. For example, read command 603 is executed as a fast command 284 based on the current mode of operation.

In one embodiment, read command 603 can include a data pointer type field 609 (e.g., configured at a same bit segment as data pointer type field 608 in the Type A read command 602). In one embodiment, field 609 is configured in the same way as data pointer type field 608 to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0. In another embodiment, field 609 can carry a value that is reserved in a current standard of NVMe; and when the value is specified in the command 603, the memory sub-system 101 is to interpret the command 603 according to the field definitions for Type B. In a further embodiment, the Data pointer type field 609 is not defined in a “Type B” read command 603.

In one embodiment, read command 603 uses a buffer identifier as an address for data transfer. When a host system desires to use the buffer identifier, the host system writes a value of 0x0 in command Dwords 6-7 when generating read command 603. This is an illegal system address, so the SSD knows that the address in command Dwords 6-7 is implicitly not valid. As a result, the SSD knows to use the identifier of the buffer specified in command Dwords 8-9. The SSD executes the command by using the address that has been loaded in a table at the address identified by the identifier. In one example, the value of the opcode provided in opcode field 605 can be the same (e.g., 0x02) as used in opcode field 604, and a command is indicated as being a Type B read command 603 based on the data pointer type being indicated as a buffer identifier.

In one embodiment, the data pointer type 609 in the read command 603 can have a value to indicate the use of a buffer identifier as in the field of “data pointer” 617 as discussed above; and the read command 603 can further support the use of other values associated with PRP (Physical Region Page) or SGL (Scatter Gather Lists) as currently defined for Type A read command 602 according to a current standard of NVMe. In this way, read command 603 can use a PRP or SGL option similarly as is available for read command 602. Data pointer type 609 is configured in the same bit segments as data pointer type 608. Alternatively, the PRP option and/or SGL option can be disabled for the Type B read command 603 to simplify and/or eliminate the data pointer type field 609. When a field of Type A read command 602 is “eliminated” from Type B read command 603, the bit segment used for the field in Type A read command 602 is not used in Type B read command 603 (e.g., having no defined meaning for Type B read command 603) or repurposed to be used for a new field not found in the Type A read command 602.

Command identifier field 611 is used for identifying commands in a queue. Command identifier field 611 is configured in command Dword 0 in the same way as command identifier field 610 of Type A read command 602. Configuring the command identifier field 611 as currently specified in the NVMe standard for Type A read command 602 can support NVMe compatibility.

Namespace identifier field 613 specifies the namespace that read command 603 applies to. Namespace identifier field 613 is configured in the same way as namespace identifier field 612 to support NVMe compatibility.

Metadata pointer field 615 is configured to carry a memory address of metadata. In one embodiment, if data pointer type field 609 is configured in the same way as data pointer type field 608, the memory address is provided in metadata pointer field 615 in a way according to the option specified in the data pointer type field 609 for the execution of the read command 603. If data pointer type field 609 is not configured in the same way as data pointer type field 608, metadata pointer field 615 can be configured in bytes 23:16 of command Dwords 4-5 as currently specified in the NVMe standard for Type A read command 602 to support NVMe compatibility in some cases.

Data pointer field 617 specifies the location of data used to store the result of executing the read command 603. Data pointer field 617 can be configured to provide a pointer to the location in the form of a memory address or a buffer identifier that has a predefined memory address.

In one embodiment, data pointer field 617 provides a memory address as a data pointer value. This value is carried in command Dwords 6-7. In one example, the memory address is a host system physical address. In one example, the address is a virtual machine physical address.

The memory address is carried in command Dwords 6:7 as done for current NVMe commands Type A read command 602. Because the PRP and SGL options are not used by Type B read command 603, command Dwords 8-9 are unused. This approach provides backward compatibility with existing NVMe standards. Unlike Type A read command 602, only a single address is used in Type B read command 603.

In one embodiment, data pointer field 617 provides a buffer identifier in command Dwords 8-9. A host system indicates the use of the buffer identifier by writing an invalid memory address in command Dwords 6-7. For example, the host system generates read command 603 by writing 0x0 in Dwords 6-7. This is an illegal system address, so an SSD knows that the address is implicitly not valid and determines that the command is to be processed as a Type B read command 603. As a result, the SSD uses the identifier (ID) of the buffer specified in command Dwords 8-9 to determine the memory address for data transfer (e.g., using a buffer lookup table).

Starting LBA field 619 indicates the 64-bit address of the first logical block to be read as part of the read operation for read command 603. This field can be configured in bits 63:00 of command Dword 10-11 in the same way as for starting LBA field 618 to support compatibility with the NVMe standard.

Data length field 621 specifies a data length (e.g., the size of the data to be read from the storage space or written to the storage space). Read command 603 defines the data length as a number of consecutive units of data to be read. In one example, the unit of data can be a byte, word, double word, or cacheline (e.g., 128 bytes).

In one example, the data length can extend over multiple logical blocks. Also, the range of data represented by the data length is not necessarily aligned with a logical block boundary; and a data offset from the logical block boundary corresponding to a starting LBA address specified starting LBA field 619.

In one embodiment, read command 603 includes a unit field (not shown) predefined at a bit segment in read command 603; and a value specified in the unit field identifies the unit size. In some implementations, the size of the unit is computed from the value (e.g., as 2 to the power of the value).

Data offset field 623 specifies where the data transfer begins inside the first LBA to read or write. The first LBA is identified by the value in starting LBA field 619.

To implement this in one example, Dword 13 of Type A read command 602 can be repurposed. In one embodiment, all parameter fields configured in Dword 13 of Type A read command 602 are either removed or reconfigured as pre-set parameters to provide via namespace attributes so that Dword 13 of Type B read command 603 is available for carrying the data offset. For example, a request to read 128 bytes, starting from byte 1024 of LBA 0x1234 can be expressed by using Dword 10-11 for LBA (0x1234), Dword 12 for length (128 bytes), and Dword 13 for offset (1024). Optionally, the data offset field 623 can be configured in other locations of read command 603 that are not used to carry other parameters.

In one embodiment, one or more fields included in read command 602 are not used in read command 603. Instead, default values can be pre-selected for each of these fields to reduce or eliminate the need for real-time processing of these parameters as each command is retrieved. For example, some parameters can be associated to a namespace and stored by a controller as namespace attributes. In this way, default values stored as namespace attributes can be applied to each read command 603 that identifies the namespace.

In other cases, some of these parameters can be implemented as a default configuration for read commands 603 regardless of any namespace identification and the command.

For example, control parameters field 624, data set management field 626, and end-to-end protection parameters field 628 are not included in read command 603. Instead, values for these parameters are stored as pre-set parameters prior to retrieving read command 603. These parameters are used by controller when executing read command 603. For example, the use of these pre-set parameters avoids using, or reduces usage of, firmware-based resources 290 when executing fast command 284.

In one embodiment, fused operation field 622 is not included in read command 603. In some cases, a default value can be implemented to use fused operation with Type B read command 603. In some cases, the default value can be implemented as a namespace attribute.

FIG. 7 shows two types (Type A and Type B) of write commands according to one embodiment. For example, the write commands can be retrieved by a controller 115 of a memory sub-system 101 from a submission queue 270 for execution within the memory sub-system 101.

Type A write command 702 carries various parameters in compliance with a current NVMe standard. The parameters define the scope, requirements, resources, etc. of operations to be performed during execution of the command. This command execution includes firmware processing for at least some of the parameters. In one example, write command 702 is a normal command 282.

Type B write command 703 carries various parameters used in command processing by the non-volatile memory sub-system. In some cases, the processing of these commands does not require, or reduces the extent of, firmware processing (e.g., due to elimination of fields used in Type A write command 702). In other cases, the processing of one or more parameters of these commands may use firmware processing. The number of parameters and/or options defined by write command 703 are reduced relative to the number of parameters and/or options defined in write command 702 (e.g., write command 703 does not include dataset management field 726 or end-to-end protection parameters field 728). In some cases, certain parameters and/or options are not included in write command 703 to provide accelerated processing. In one example, write command 703 is a fast command 284.

In one example, write command 702 and write command 703 can be configured, with embedding appropriate parameters in various fields of the commands 702 and 703, to cause a controller 115 of the memory sub-system 101 to perform an identical operation of reading a block of data from a same memory location in the memory 264 of the host system 102 and writing the block of data to non-volatile memory implementing the storage space 261. Although the backend operation is the same in each case, write command 703 has fewer fields than write command 702, or write command 703 skips one or more fields that are processed for write command 702.

Various parameters of Type A write command 702 are now described below. These parameters are indicated by values provided in various defined fields of write command 702. Various parameters of Type B write command 703 are also described below to illustrate similarities and differences of the fields configured to carry the parameters as compared to Type A write command 702. These parameters are indicated by values provided in various defined fields of write command 703.

Opcode field 704 of Type A write command 702 specifies the opcode of the command to be executed. For example, an opcode value of 0x01 can be used in the opcode field to identify the command as a write command according to the NVMe standard. The opcode value is configured in bits 07:00 of command Dword 0.

For example, an opcode in opcode field 704 has 8 bits. Bits 7:2 indicate Function, and bits 1:0 indicate Data Transfer. For example, a value of 01b for bits 1:0 indicates a data transfer for a write. The Function portion of the opcode for write is 0. Thus, the combined opcode (the entire opcode value) is 01h in hexadecimal.

Opcode field 705 of Type B write command 703 also specifies the opcode of the command to be executed. The opcode value can be configured in bits 07:00 of command Dword 0 (same location as for write command 702) for compatibility with the NVMe standard, or can be configured in another bit segment or location of the command. For example, the value of the opcode can indicate that the command is a fast command 284.

In one embodiment, a new opcode is defined for Type B write command 703. For example, the opcode can be a vendor specific opcode for I/O commands (in the range of 80h to FFh). For example, a value of 0x81 can be used to provide a fast vendor specific write command that is in compliance with the NVMe standard for vendor specific extensions.

Optionally, write command 703 is configured to further include a Type B indicator 707 configured to indicate to the controller whether the command 703 containing the Type B indicator 707 is to be processed to have the fields as defined for Type B write command 703. For example, Type B indicator 707 can be a single-bit field configured in a bit segment that is reserved in a write command according to a current NVMe standard. When a first value (e.g., “1”), is specified in Type B indicator 707, the controller 115 of the memory sub-system 101 can recognize the command 203 as a “Type B” write command having the fields as configured in a way different from the “Type A” write command 702, even when the same opcode “0x01” is used in the command 703. When a “Type B indicator 707” is used to differentiate a “Type A” write command 702 and a “Type B” write command 703, the use of the “Type A” command 702 is to be modified to also include the field of “Type B indicator 707” at the same single-bit field that is reserved in a current NVMe standard; and when a second value (e.g., “0”) is specified in the field, the memory sub-system 101 can recognize that the command is a “Type A” command 702 having fields as defined differently from the “Type B command 703”.

Alternatively, whether a write command is a “Type A” write command 702 or a “Type B” write command 703 is based on the use of different opcodes in the opcode fields. In one embodiment, Type B indicator 707 is configured to indicate that the command 703 containing it is a “Type B command 703” based on a specific value provided in a field that is also defined in the “Type A command 702” where the meaning of the specific value in the field is reserved according to a current NVMe standard so that the controller interprets the presence of the specific value in the field is an indication that the retrieved command 703 is to be interpreted in a way as illustrated for the Type B write command 703, different from the field definitions of Type A write command 702.

In some implementations, a memory sub-system 101 is configured to support the “Type B” write command 703 without supporting the Type A write command 702 that is in compliance with a current NVMe standard. In such implementations, it can be unnecessary to have a “Type B indicator 707”, and the same opcode 0x01 currently used for “Type A” write command 702 can be reused as the opcode for “Type B” write command 703.

In one embodiment, the value of the opcode provided in opcode field 705 can be the same (e.g., 0x01) as used in opcode field 704, and a command is indicated as being a Type B write command 703 (e.g., a fast command 284) in another way such as including a flag in another bit segment (e.g., in Dword 14 or 15) of the command.

In one embodiment, the value of the opcode provided in opcode field 705 can be the same (e.g., 0x01) as used in opcode field 704, and a command is indicated as being a Type B write command 703 (e.g., a fast command 284) in another way based on a mode of operation of a controller or a non-volatile memory system. In this case, Type B indicator 707 is not required in write command 703 itself. For example, write command 703 is executed as a fast command 284 based on the current mode of operation.

Data pointer type field 708 of write command 702 is configured to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0. If the PSDT option is set to 01b or 10b (indicates use of SGL), a controller can use Scatter-Gather Lists (SGL) in two ways similarly as discussed above for read command 602.

In one embodiment, write command 703 can include a data pointer type field 709 (e.g., configured at a same bit segment as data pointer type field 708 in the Type A write command 702). In one embodiment, field 709 is configured in the same way as data pointer type field 708 to carry a PSDT option selected by the host system 102 regarding user data transferred during the execution of the command (e.g., whether PRP (Physical Region Page) or SGL (Scatter Gather Lists) is used for data transfer (PSDT)). The data pointer type is configured in bits 15:14 of command Dword 0. In another embodiment, field 709 can carry a value that is reserved in a current standard of NVMe; and when the value is specified in the command 703, the memory sub-system 101 is to interpret the command 703 according to the field definitions for Type B. In a further embodiment, the Data pointer type field 709 is not defined in a “Type B” write command 703.

In one embodiment, write command 703 uses a buffer identifier as an address for data transfer. When a host system desires to use the buffer identifier, the host system writes a value of 0x0 in command Dwords 6-7 when generating write command 703. This is an illegal system address, so the SSD knows that the address in command Dwords 6-7 is implicitly not valid. As a result, the SSD knows to use the identifier of the buffer specified in command Dwords 8-9. The SSD executes the command by using the address that has been loaded in a table at the address identified by the identifier. In one example, the value of the opcode provided in opcode field 705 can be the same (e.g., 0x01) as used in opcode field 704, and a command is indicated as being a Type B write command 703 based on the data pointer type being indicated as a buffer identifier.

In one embodiment, the data pointer type field 709 in the write command 703 can have a value to indicate the use of a buffer identifier as in the field of “data pointer” 717 as discussed above; and the write command 703 can further support the use of other values associated with PRP (Physical Region Page) or SGL (Scatter Gather Lists) as currently defined for Type A write command 702 according to a current standard of NVMe. In this way, write command 703 can use a PRP or SGL option similarly as is available for write command 702. Data pointer type 709 is configured in the same bit segments as data pointer type 708.

Alternatively, the PRP option and/or SGL option can be disabled for the Type B write command 703 to simplify and/or eliminate the data pointer type field 709. When a field of Type A write command 702 is “eliminated” from Type B write command 703, the bit segment used for the field in Type A write command 702 is not used in Type B write command 703 (e.g., having no defined meaning for Type B write command 703) or repurposed to be used for a new field not found in the Type A write command 702.

Command identifier field 710 specifies a unique identifier for the write command 702 when combined with the submission queue identifier. This field is configured in bits 31:16 of command Dword 0.

Command identifier field 711 of write command 703 is used for identifying commands in a queue. Command identifier field 711 is configured in command Dword 0 in the same way as command identifier field 710 of Type A write command 702. Configuring the command identifier field 711 as currently specified in the NVMe standard for Type A write command 702 can support NVMe compatibility.

Namespace identifier field 712 specifies the namespace that write command 702 applies to. This field is configured in bytes 07:04 of command Dword 1.

Namespace identifier field 713 specifies the namespace that write command 703 applies to. Namespace identifier field 713 is configured in the same way as namespace identifier field 712 to support NVMe compatibility.

Metadata pointer field 714 is configured to carry a memory address of metadata provided in a way according to the option specified in the data pointer type field for the execution of the write command 702. This field is configured in bytes 23:16 of command Dword 4-5.

Metadata pointer field 715 is configured to carry a memory address of metadata. In one embodiment, if data pointer type field 709 is configured in the same way as data pointer type field 708, the memory address is provided in metadata pointer field 715 in a way according to the option specified in the data pointer type field 709 for the execution of the write command 703. If data pointer type field 709 is not configured in the same way as data pointer type field 708, metadata pointer field 715 can be configured in bytes 23:16 of command Dwords 4-5 as currently specified in the NVMe standard for Type A write command 702 to support NVMe compatibility in some cases.

Data pointer field 716 specifies the data used in the write command 702. This field is configured in bytes 39:24 of command Dword 6-9.

Data pointer field 717 specifies the location of data to be written (e.g., location of a data buffer in memory 264 where data is transferred from) when executing the write command 703. Data pointer field 717 can be configured to provide a pointer to the location in the form of a memory address or a buffer identifier that has a predefined memory address.

In one embodiment, data pointer field 717 provides a memory address as a data pointer value. This value is carried in command Dwords 6-7. In one example, the memory address is a host system physical address. In one example, the address is a virtual machine physical address.

The memory address is carried in command Dwords 6:7 as done for current NVMe commands Type A write command 702. Because the PRP and SGL options are not used by Type B write command 703, command Dwords 8-9 are unused. This approach provides backward compatibility with existing NVMe standards. Unlike Type A write command 702, only a single address is used in Type B write command 703.

In one embodiment, data pointer field 717 provides a buffer identifier in command Dwords 8-9. A host system indicates the use of the buffer identifier by writing an invalid memory address in command Dwords 6-7. For example, the host system generates write command 703 by writing 0x0 in Dwords 6-7. This is an illegal system address, so an SSD knows that the address is implicitly not valid and determines that the command is to be processed as a Type B write command 703. As a result, the SSD uses the identifier (ID) of the buffer specified in command Dwords 8-9 to determine the memory address for data transfer (e.g., using a buffer lookup table).

Starting LBA field 718 indicates the 64-bit address of the first logical block to be written as part of the write operation for write command 702. This field is configured in bits 63:00 of command Dword 10-11.

Starting LBA field 719 indicates the 64-bit address of the first logical block to be written as part of the write operation for write command 703. This field can be configured in bits 63:00 of command Dwords 10-11 in the same way as for starting LBA field 718 to support compatibility with the NVMe standard.

Number of logical blocks field 720 indicates the number of logical blocks to be written when executing write command 702. This field is configured in bits 15:00 of command Dword 12.

Data length field 721 specifies a data length (e.g., the size of the data to be written to the storage space). Write command 703 defines the data length as a number of consecutive units of data to be written. In one example, the unit of data can be a byte, word, double word, or cacheline (e.g., 128 bytes).

In one example, the data length can extend over multiple logical blocks. Also, the range of data represented by the data length is not necessarily aligned with a logical block boundary; and a data offset from the logical block boundary corresponding to a starting LBA address specified starting LBA field 719.

In one embodiment, write command 703 includes a unit field (not shown) predefined at a bit segment in write command 703; and a value specified in the unit field identifies the unit size. In some implementations, the size of the unit is computed from the value (e.g., as 2 to the power of the value).

Data offset field 723 specifies where the data transfer begins inside the first LBA to write or write. The first LBA is identified by the value in starting LBA field 719.

To implement this in one example, Dword 13 of Type A write command 702 can be repurposed. In one embodiment, all parameter fields configured in Dword 13 of Type A write command 702 are either removed or reconfigured as pre-set parameters to provide via namespace attributes so that Dword 13 of Type B write command 703 is available for carrying the data offset. For example, a request to write 128 bytes, starting from byte 1024 of LBA 0x1234 can be expressed by using Dword 10-11 for LBA (0x1234), Dword 12 for length (128 bytes), and Dword 13 for offset (1024). Optionally, the data offset field 723 can be configured in other locations of write command 703 that are not used to carry other parameters.

Fused operation field 722 specifies whether write command 702 is part of a fused operation and if so, which command it is in the sequence. This field is configured in bits 09:08 of command Dword 0.

In one embodiment, fused operation field 722 is not included in write command 703. For example, the bits 09:08 of command Dword 0 used to implement the fused operation field 722 in the write command 702 can be reserved, not used, or repurposed to host a different field for another parameter for write command 703. The write command 703 can be executed with the pre-defined default value of no fused operation, regardless of what is specified in the bits 09:08 of command Dword 0 of write command 703.

Control parameters field 724 corresponds to the parameters for “Limited Retry (LR)”, “Force Unit Access (FUA)”, “Protection Information Field (PRINFO)”, “Storage Tag Check (STC)”, “Directive Type (DTYPE)”, and “Directive Specific (DSPEC)” defined in command Dwords 12-13 for a write command in a current NVMe standard.

“Limited Retry (LR)” indicates whether the controller should apply limited retry efforts when executing the command and is configured in bit 31.

“Force Unit Access (FUA)” is a flag configured in bit 30. If the flag is set to 1, then data and metadata associated with logical blocks specified by write command 702 is written to non-volatile media before indicating command completion.

“Protection Information Field (PRINFO)” is configured in bits 29:26 and specifies the protection information action and check field. “Storage Tag Check (STC)” is configured in bit 24 and specifies the Storage Tag field is to be checked as part of end-to-end data protection processing.

“Directive Type (DTYPE)” is configured in bits 23:20 and specifies the Directive Type associated with the Directive Specific field of command Dword 13.

“Directive Specific (DSPEC)” is configured in bits 31:16 of command Dword 13 and specifies the Directive Specific value associated with the Directive Type field of command Dword 12.

Dataset management field 726 indicates attributes for the LBA addresses being written when executing write command 702. The dataset management field 726 is configured in bits 07:00 of command Dword 13. For example, bit 6 “Sequential Request” can be set to inform the controller that this write is part of a sequential write that includes multiple write commands. Other attributes include indications for access frequency and latency tolerance for the LBA range being written. These attributes can provide guidance to the controller for configuring how it writes data.

End-to-end protection parameters field 728 corresponds to the parameters defined in Dwords 2, 3, 14, and 15. Bits 47:00 of command Dwords 2-3 and bits 31:00 of command Dword 14 specify the variable sized Logical Block Storage Tag (LBST) and Initial Logical Block Reference Tag (ILBRT) fields. If the namespace identified in the write command is not formatted to use end-to-end protection information, then these fields are ignored.

The Logical Block Application Tag Mask (LBATM) field is configured in bits 31:16 of command Dword 15. This field specifies the Application Tag Mask value. The Logical Block Application Tag (LBAT) field is configured in bits 15:00 of command Dword 15. This field specifies the Application Tag value. If the namespace identified in the write command is not formatted to use end-to-end protection information, then these fields are ignored.

In one example, NVMe supports an end-to-end data protection feature that can be used to guard against data corruption between the host and the storage space 261 (e.g., NAND flash) of SSD 260 as discussed above. The write command's PRINFO and STC fields (configured in command Dword 12) allow the host to specify what integrity checks to perform. End-to-end protection, when enabled, can improve reliability by detecting corruption that might occur in the write path.

In one embodiment, one or more of the Control parameters field 724 (e.g., LR, FUA, PRINFO, STC, DTYPE, and DSPEC), Dataset management field 726, and End-to-end protection parameters field 728 included in write command 702 are omitted and thus not included or used in write command 703. The corresponding bits of the Type B write command 703, which host such omitted fields of Type A write command 702 can be reserved, not used, or repurposed to host a different field for another parameter (e.g., Data offset field 723) of the Type B write command 703. Instead, default values can be pre-selected for each of these fields to reduce or eliminate the need for real-time processing of these parameters as each command is retrieved. For example, some parameters can be associated to a namespace and stored by a controller as namespace attributes. In this way, default values stored as namespace attributes can be applied to each write command 703 that identifies the namespace using the Namespace identifier field 713.

In other cases, some of these parameters can be implemented as a default configuration for write commands 703 regardless of any namespace identification and the command.

For example, control parameters field 724, data set management field 726, and end-to-end protection parameters field 728 are not included in write command 703. Instead, values for these parameters are stored as pre-set parameters prior to retrieving write command 703. These parameters are used by controller when executing write command 703. For example, the use of these pre-set parameters avoids using, or reduces usage of, firmware-based resources 290 when executing fast command 284.

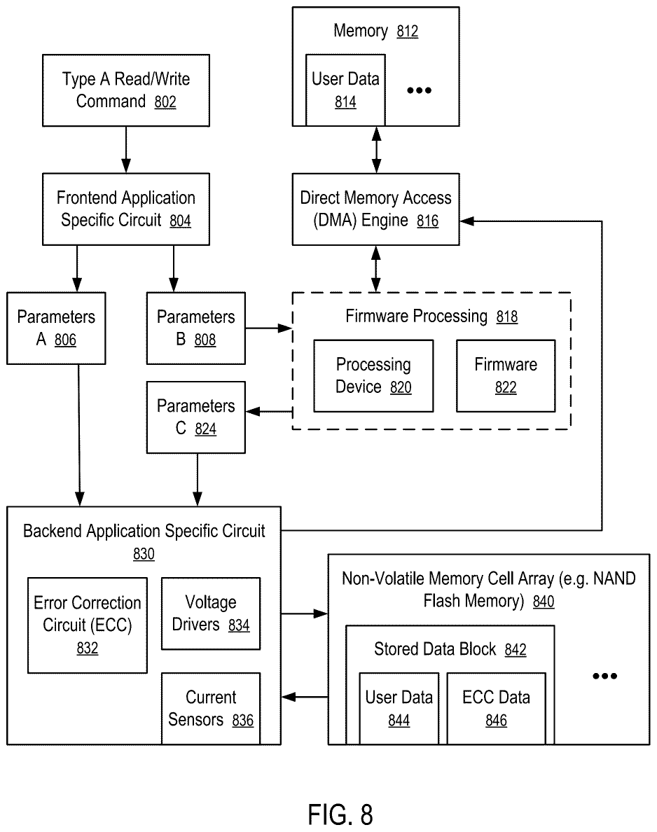

FIG. 8 shows a processing path for Type A read or write commands 802 according to one embodiment. For example, the commands can be Type A read command 602 and Type A write command 702. For example, the read or write commands can be retrieved from submission queue 270 by controller 294. In one example, the read or write commands are normal commands 282.

Various parameters of each retrieved command 802 are extracted and/or processed by frontend application specific circuit 804.

In one example, frontend application specific circuit 804 is configured in hardware circuitry 292 of solid-state drive 260. Circuit 804 parses values of the parameters and performs various processing depending on the specific parameter. In one example, the parameters are defined in accordance with a current version of the NVMe standard. Results from the processing are provided as Parameters A 806 and Parameters B 808.

Parameters B 808 are further processed using firmware processing 818. This processing includes execution of firmware 822 by processing device 820. In one example, processing is performed to evaluate parameters in accordance with a current version of the NVMe standard. Results from the firmware processing 818 are provided as Parameters C 824. In one example, firmware processing 818 uses firmware-based resources 290.

In some cases, the processing of some parameters can cause the firmware processing 818 to perform operations to access memory 812, e.g., using a direct memory access (DMA) engine 816, to fetch further data (e.g., metadata, SGL entries, PRP entries) from memory 812 according to pointers or addresses provided in the command 802.

Parameters A 806 and Parameters C 824 are provided as inputs to backend application specific circuit 830. In one example, backend application-specific circuit 830 is configured as a local controller on a NAND flash memory chip. Backend application-specific circuit 830 accesses non-volatile memory cell array 840 in response to receiving, and as defined by, Parameters A 806 and Parameters C 824.

For example, when a solid-state drive executes a read command 802, backend application-specific circuit 830 reads at least a portion of user data 844 and corresponding ECC data 846 from stored data block 842. Error correction circuit 832 is used to correct any errors found in the read data. Memory cells of stored data block 842 are accessed by applying voltages to access lines (not shown) of memory cell array 840 using voltage drivers 834. Current sensors 836 are used to sense voltages or currents on at least a portion of the access lines to determine values (e.g., logic 1 or 0) of the stored data.

For example, when a solid-state drive executes a write command 802, backend application-specific circuit 830 programs memory cells of memory cell array 840 to store user data 814 transferred from memory 812 (e.g., DRAM) of a host system. Error correction circuit 832 generates ECC data 846 for the user data 844 to be written. Voltage drivers 834 apply voltages to access lines (not shown) of memory cell array 840 to program memory cells of stored data block 842. The memory cells are programmed so that states of the memory cells correspond to the user data 844 and ECC data 846 to be stored as part of executing write command 802.

In response to a read command 802, backend application-specific circuit 830 reads user data 844 using operations defined by Parameters A 806 and Parameters C 824. For example, these parameters identify an LBA address of a logical block from which data is to be read. A flash translation layer converts the LBA address into a physical address in non-volatile memory cell array 840. The corrected user data 844 is transferred to memory 812 using direct memory access engine (DMA) 816. For example, user data 814 is transferred to a memory address of memory 812 provided by data pointer field 616 of a read command 602.

In response to a write command 802, backend application-specific circuit 830 writes user data 844 using operations defined by Parameters A 806 and Parameters C 824. For example, these parameters identify an LBA address of a logical block in which data is to be written. A flash translation layer converts LBA address into a physical address in non-volatile memory cell array 840. The user data 844 to be written is transferred from memory 812 using direct memory access engine (DMA) 816. For example, user data 814 is transferred from a memory address of memory 812 provided by data pointer field 716 of a write command 702.

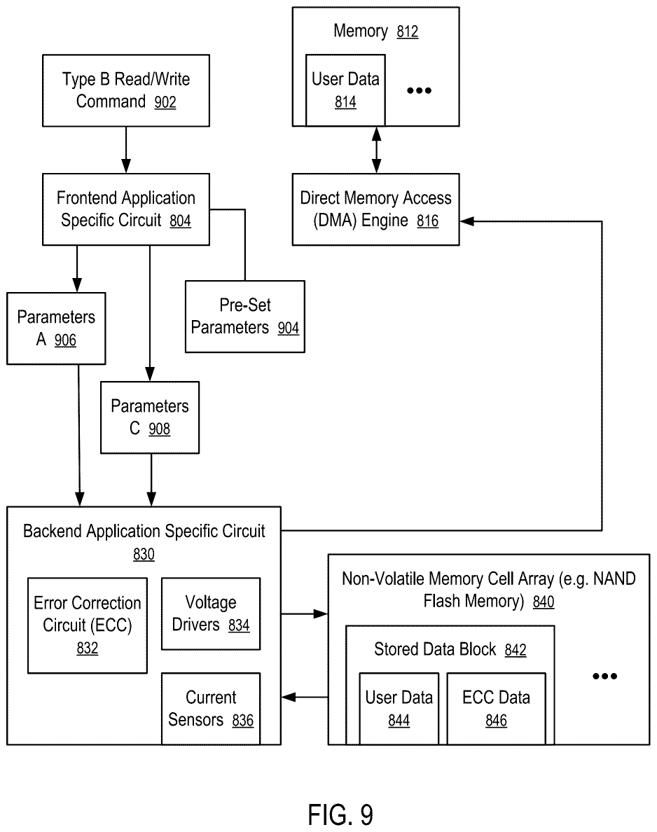

FIG. 9 shows a processing path for Type B read or write commands 902 according to one embodiment. For example, the commands can be Type B read command 603 and Type B write command 703. For example, the read or write commands can be retrieved from submission queue 270 by controller 294. In one example, the read or write commands are fast commands 284.

Various parameters of each retrieved read/write command 902 are extracted and/or processed by frontend application specific circuit 804 in view of pre-set parameters 904. In one example, frontend application specific circuit 804 is configured in hardware circuitry 292 of solid-state drive 260. The use of the pre-set parameters 904 allows the skipping of the firmware processing 818 that is to be performed in FIG. 8 during the execution of the Type A read/write command 802. Frontend application specific circuit 804 can generate Parameters A 906 and Parameters C 908 with the firmware processing 818 of FIG. 8.

Parameters C 908 are generated in part based on pre-set parameters 904. Pre-set parameters 904 are stored from prior processing of one or more retrieved commands. For example, pre-set parameters 904 are results stored from prior firmware processing 818 of parameters in prior commands.

This prior processing may be performed during execution of a prior read/write command (e.g., 602 or 702 modified to include a flag to save its parameters as default values for future processing of Type B read/write commands 603 and 703). In one example, the prior processing generates these results (that are stored as pre-set parameters 904) using one or more parameters carried by read command 602 or write command 702 in control parameters field 724, dataset management field 726, and/or end-to-end protection parameters field 728. In some examples, pre-set parameters 904 includes one or more of these parameters previously stored as namespace attributes (e.g., during the execution of a command to set or change one or more attributes of a namespace) prior to retrieving read/write command 902. The namespace attributes can be selected by a controller according to the namespace identifier field 713 of a write command 703 or namespace identifier field 613 of a read command 603.

Backend application-specific circuit 830 receives Parameters A 906 and Parameters C 908 as inputs. In response, backend application-specific circuit 830 accesses stored data block 842 similarly as discussed above.

In one example, backend application-specific circuit 830 performs the same operations in accessing non-volatile memory cell array 840 for each of a retrieved read/write command 802 and a retrieved read/write command 902. However, processing of command 902 uses pre-set parameters 904 and is accelerated relative to processing of command 802, which uses firmware processing 818. Command 902 can be processed in an accelerated way because one or more fields used in command 802 have been eliminated from command 902. In one example, the pre-set parameters 904 are generated from firmware processing 818 of certain parameters carried by command 802 and are stored as namespace attributes. Command 902 includes a namespace identifier used by a controller to select pre-set parameters 904. Each namespace can be associated with different pre-set parameters 904.

In one example, backend application-specific circuit 830 performs the operation of reading an entire logical block from an LBA address in stored data block 842. The LBA address is converted to a physical address by a flash translation layer (not shown). The reading of the logical block by backend application-specific circuit 830 is performed in the same way for both Type A read command 802 and Type B read command 902.

In one embodiment, both Type A and Type B read/write commands 802, 902 use a compatible data layout for data stored in a stored data block 842. For example, user data 844 and ECC data 846 written to block 842 with a Type A write command 802 can be read from block 842 using a Type B read command 902. User data 844 and ECC data 846 written to block 842 with a Type B write command 902 can be read from the block 842 using a Type A read command 802.

In one embodiment, at least some of the pre-set parameters 904 are default options used for processing read/write command 902. The default options are applied without regard to a particular namespace identified by the command.

In one embodiment, at least some of pre-set parameters 904 are generated using firmware processing 818 during the execution of one or more commands before the execution of the Type B read/write command 902. When executing read/write command 902, the pre-set parameters 904 can be used as needed during the execution of the command 902. This avoids needing to perform the firmware processing 818 in real-time when executing command 902.

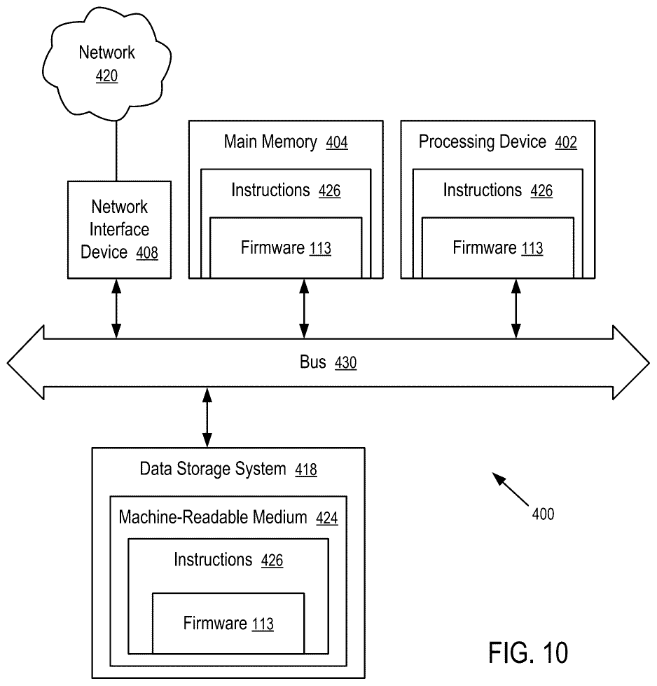

FIG. 10 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of firmware 113 (e.g., to execute instructions to perform operations corresponding to the firmware 113 described with reference to FIGS. 1-9). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

In one example, instructions 426 are executed to configure processing of normal and/or fast commands. In one example, instructions 426 are executed to configure firmware-based resources 290 and/or hardware circuitry 292 based on an opcode in a command.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the firmware 113 described with reference to FIGS. 1-9. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory sub-system comprising:
non-volatile memory; and
at least one controller configured to:
retrieve a first read command, wherein the first read command includes a first opcode configured to cause the controller to transfer first data to a memory location identified via the first read command from the non-volatile memory, and the first opcode has a value of 0x02;
execute the first read command to transfer the first data;
retrieve a second read command, wherein the second read command includes a second opcode different from the first opcode, and the second opcode is configured to cause the controller to transfer second data to a memory location identified via the second read command from the non-volatile memory; and
execute the second read command to transfer the second data.

2. The memory sub-system of claim 1, wherein the first read command includes a first field configured at a predetermined location in the first read command according to the standard for NVMe, a parameter provided in the first field is processed when executing the first read command to write the first data, a field definition pre-specified for the second command does not include the first field being configured at the same predetermined location in the second read command, and a content provided at the same predetermined location in the second read command is ignored when executing the second read command.

3. The memory sub-system of claim 2, wherein the first field is a fused operation field.

4. The memory sub-system of claim 2, wherein the first field is a control parameters field.

5. The memory sub-system of claim 2, wherein the first field is a dataset management field.

6. The memory sub-system of claim 2, wherein the parameter provided in the first field relates to end-to-end protection.

7. The memory sub-system of claim 1, wherein the first data is transferred to the memory location identified via the first read command from a first storage location in a storage space identified via a logical block addressing (LBA) address provided in the first read command.

8. The memory sub-system of claim 7, wherein the storage location is further identified via a namespace identifier provided in the first read command.

9. The memory sub-system of claim 8, wherein the namespace identifier is specified in the first read command in byte segment 7:4.

10. The memory sub-system of claim 8, wherein the namespace identifier is specified in each of the first and second read commands in accordance with an NVMe standard.

11. The memory sub-system of claim 1, wherein each of the first and second read commands has a predetermined length of 512 bits.

12. The memory sub-system of claim 1, wherein the first opcode is according to a standard for non-volatile memory express (NVMe) of August 2024.

13. A memory sub-system, comprising:
non-volatile memory; and
a controller configured to:
retrieve a first command, the command including:
a first opcode configured to cause the controller to read data from the non-volatile memory;
a logical block addressing (LBA) address identifying a block in a logical storage space partitioned into a plurality of logical blocks of a common size; and
a memory address in random access memory; and
execute the first command to transfer the data from the block to the random access memory according to the memory address;
wherein the first opcode is different from a second opcode according to a standard for non-volatile memory express (NVMe);
wherein when the first opcode in the first command is replaced with the second opcode to generate a second command, the second command includes a plurality of bit segments configured to provide parameters according to the standard for non-volatile memory express (NVMe) to read the data from the logical block address; and
wherein the controller is configured to, in response to the first opcode being specified in the first command, skip processing of the plurality of bit segments in execution of the first command.

14. The memory sub-system of claim 13, wherein a value of the second opcode is 0x02.

15. The memory sub-system of claim 13, wherein the parameters according to the standard include a fused operation parameter.

16. The memory sub-system of claim 13, wherein the parameters according to the standard relate to end-to-end protection.

17. The memory sub-system of claim 13, wherein each of the first and second commands has a predetermined length of 512 bits.

18. A memory sub-system, comprising:
non-volatile memory; and
a controller configured to:
retrieve a first command from a submission queue, the command including:
a first opcode configured to cause the controller to read data from the non-volatile memory;
a logical block addressing (LBA) address identifying a block in a logical storage space partitioned into a plurality of logical blocks of a common size; and
a memory address in random access memory; and
execute the first command to retrieve the data from a portion of the non-volatile memory allocated to implement the block represented by the logical block addressing (LBA) address, and store the data to the random access memory according to the memory address;
wherein the first opcode is different from a second opcode according to a standard for non-volatile memory express (NVMe);
wherein when the first opcode in the first command is replaced with the second opcode to generate a second command, the second command includes a plurality of bit segments configured to provide parameters according to the standard for non-volatile memory express (NVMe) to read the data from the logical block address; and
wherein the controller is configured to, in response to the first opcode being specified in the first command, skip processing of the plurality of bit segments in execution of the first command.

19. The memory sub-system of claim 18, wherein the parameters according to the standard include control parameters.

20. The memory sub-system of claim 18, wherein the parameters according to the standard relate to dataset management.
